(19) United States
(12) Patent Application Publication
(10) Pub. No.: US 2024/0206463 A1
(43) Pub. Date: Jun. 27, 2024

(54) AGROCHEMICAL COMPOSITION

(71) Applicant: NOURYON CHEMICALS INTERNATIONAL B.V., Amsterdam (NL)

(72) Inventor: Shawn ZHU, Stormville, NY (US)

(73) Assignee: NOURYON CHEMICALS INTERNATIONAL B.V., Amsterdam (NL)

(21) Appl. No.: 18/551,225

(22) PCT Filed: Mar. 17, 2022
(86) PCT No.: PCT/EP2022/057071

§ 371 Date: Sep. 19, 2023

Related U.S. Application Data
(60) Provisional application No. 63/200,637, filed on Mar. 19, 2021.
(60) Provisional application No. 63/201,866, filed on May 17, 2021.

(51) Int. Cl. A01N 37/02; A01N 25/04; A01N 25/30; A01N 35/06; A01N 37/26; A01N 37/40; A01N 43/82; A01N 47/20; A01N 57/12; A01N 57/20; A01P 3/00; A01P 7/02; A01P 13/00

(52) U.S. Cl. CPC A01N 37/02; A01N 25/04; A01N 25/30; A01N 35/06; A01N 37/26; A01N 37/40; A01N 43/82; A01N 47/20; A01N 57/12; A01N 57/20; A01P 3/00; A01P 7/02; A01P 13/00

(57) ABSTRACT

An agrochemical composition includes:
a linear fatty acid having a C8 to C10 alkyl chain; and
an additive chosen from a diluent, an alkoxylated phosphate ester surfactant, and combinations thereof,
wherein the alkoxylated phosphate ester surfactant has a degree of alkoxylation of from about 10 to about 100 and is chosen from alkoxylated C12-C22 alkyl phosphate esters, alkoxylated phosphate esters formed from an alkoxylated triglyceride having at least one pendant hydroxyl group, an alkoxylated phosphate ester formed from an alkoxylated alkylamine, and combinations thereof; and
wherein the diluent is chosen from C4-C10 linear or branched alcohols and their propoxylates, branched C5-C10 monocarboxylic acids, methyl and ethyl esters of linear or branched C8-C10 fatty acids, tall oil fatty acid, trialkyl C2-C8 linear or branched phosphates, aromatic solvents, mineral oils, methyl benzoate, methyl salicylate, octyl acetates, octyl lactate, alkylnitriles, and combinations thereof.

### CROSS-REFERENCE TO RELATED APPLICATIONS

This application is a U.S. National-Stage entry under 35 U.S.C. § 371 based on International Application No. PCT/EP2022/057071, filed Mar. 17, 2022, which was published under PCT Article 21(2) and which claims priority to U.S. Provisional Application No. 63/200,637, filed Mar. 19, 2021, and U.S. Provisional Application No. 63/201,866, filed May 17, 2021, which are all hereby incorporated in their entirety by reference.

### TECHNICAL FIELD

This disclosure generally relates to an agrochemical composition including a linear fatty acid and an additive chosen from a diluent, an alkoxylated phosphate ester surfactant and combinations thereof. More specifically, this disclosure provides a composition useful in agricultural applications wherein the linear fatty acid is valeric acid, hexanoic acid, heptanoic acid, octanoic acid, pelargonic acid, decanoic acid, and combinations thereof.

### BACKGROUND

An emulsifiable concentrate (EC) useful in agricultural applications is a clear liquid formulation comprising an emulsifier and a hydrophobic liquid (as the continuous phase) wherein the emulsifier is dissolved in the hydrophobic liquid. An industrially acceptable EC must be stable in storage and, more importantly, it must form an emulsion upon dilution into water. The emulsion should also be stable during spraying (typically 30 minutes to 24 hours) and not exhibit significant phase separation, flocculation, etc.

An EC used in agricultural applications is an agrichemical product. Some ECs are adjuvant ECs and some are pesticide ECs. Linear C8-C10 acids are registered as pesticides (mainly as herbicides) in various countries. Pelargonic acid is registered as a pesticide as well as an adjuvant in US. The use of other shorter chain (C2-C7) monocarboxylic acids as herbicides has also been mentioned in internet but, to the best of the inventor's knowledge, their use as pesticides haven't been approved because the shorter chain fatty acids are not as efficacious as C8-C10 fatty acids. It is well known that many pesticide ECs can be formulated using, in addition to pesticides and frequently suitable solvents, three common surfactants as emulsifiers: a nonionic surfactant such a castor oil ethoxylate (Emulpon CO-360) or an alcohol ethoxylate, a calcium alkyl benzene sulfonate salt such as calcium dodecylbenzene sulfonate (Witconate P-1220EH), and a block copolymer of alkyl polyethylene oxide and polypropylene oxide such as Ethylan NS-500LQ. However, these common emulsifiers are not suitable for formulating ECs containing linear fatty acids such as valeric acid, hexanoic acid, heptanoic acid, octanoic acid, and pelargonic acid. Instead, other chemicals such as nonylphenol derived emulsifiers are used but are viewed unfavorably due to potential environmental and health concerns. Accordingly, there remains opportunities for improvement. In addition, other objects, desirable features and characteristics will become apparent from the subsequent summary and detailed description, and the appended claims, taken in conjunction with the accompanying drawings and this background.

### SUMMARY

This disclosure provides an agrochemical composition comprising:
at least one linear fatty acid selected from valeric acid, hexanoic acid, heptanoic acid, octanoic acid, and pelargonic acid; and
an additive chosen from a diluent, an alkoxylated phosphate ester surfactant, and combinations thereof,
wherein the alkoxylated phosphate ester surfactant has a degree of alkoxylation of from about 10 to about 100 and is chosen from alkoxylated C12-C22 alkyl phosphate esters, alkoxylated phosphate esters formed from an alkoxylated triglyceride having at least one pendant hydroxyl group, an alkoxylated phosphate ester formed from an alkoxylated alkylamine, and combinations thereof; and
wherein the diluent is chosen from C4-C10 linear or branched alcohols and their propoxylates, branched C5-C10 monocarboxylic acids, methyl and ethyl esters of linear or branched C8-C10 fatty acids, tall oil fatty acid, trialkyl C2-C8 linear or branched phosphates, aromatic solvents, mineral oils, methyl benzoate, methyl salicylate, octyl acetates, octyl lactate, alkylnitriles, and combinations thereof.

This disclosure further provides an aforementioned agrochemical composition plus one or more liquid or solid pesticides.

This disclosure also provides a pesticidal composition consisting essentially of:
pelargonic acid; and
a diluent,
wherein the composition comprises less than 1 wt % of water and less than 1 wt % surfactant, each based on a total weight of the composition.

This disclosure further provides a tank-mix composition comprising the aforementioned agrochemical composition. This disclosure also provides a method comprising the steps of providing the agrochemical composition and applying the pesticidal composition to a target.

### DETAILED DESCRIPTION

The following detailed description is merely exemplary in nature and is not intended to limit the agrochemical composition of this disclosure. Furthermore, there is no intention to be bound by any theory presented in the preceding background or the following detailed description. Moreover, it is contemplated that, in various non-limiting embodiments, it is to be appreciated that all numerical values as provided herein, save for the actual examples, are approximate values with endpoints or particular values intended to be read as “about” or “approximately” the value as recited.

Embodiments of the present disclosure are generally directed to agrochemical composition and methods for forming the same. For the sake of brevity, conventional techniques related to forming such compositions may not be described in detail herein. Moreover, the various tasks and process steps described herein may be incorporated into a more comprehensive procedure or process having additional steps or functionality not described in detail herein. In particular, various steps in the manufacture of agrochemical compositions are well-known and so, in the interest of brevity, many conventional steps will only be mentioned briefly herein or will be omitted entirely without providing the well-known process details.

In one embodiment, the present disclosure is related to a stable pesticide composition comprising pelargonic acid and at least one more component chosen from a surfactant, a diluent, and combinations thereof. The surfactant can be at least one phosphate ester having a degree of alkoxylation of from about 10 to about 100. This surfactant can be chosen from an alkoxylated C12-C22 alkyl phosphate ester, a phosphate ester of an alkoxylated triglyceride having at least one pendant hydroxyl group, a phosphate ester formed from an alkoxylated alkylamine, and combinations thereof. The diluent can be any liquid capable of lower the melting point of pelargonic acid.

Pelargonic acid, also known as nonanoic acid, is a linear C9 carboxylic acid with a melting point of ˜14° C. Pelargonic acid exists naturally as esters in the oil of pelargonium. The use of pelargonic acid as herbicide is desirable because pelargonic acid is a biopesticide and can be used as an alternative for glyphosate, glufosinate, and paraquat, among others.

In other embodiments, this disclosure provides a pesticidal composition comprising:
a linear fatty acid having a C5 to C10 alkyl chain; and
an additive chosen from a diluent, an alkoxylated phosphate ester surfactant, and combinations thereof,
wherein the alkoxylated phosphate ester surfactant has a degree of alkoxylation of from about 10 to about 100 and is chosen from alkoxylated C12-C22 alkyl phosphate esters, alkoxylated phosphate esters formed from an alkoxylated triglyceride having at least one pendant hydroxyl group, an alkoxylated phosphate ester formed from an alkoxylated alkylamine, and combinations thereof; and
wherein the diluent is chosen from C4-C10 linear or branched alcohols and their propoxylates, branched C5-C10 monocarboxylic acids, methyl and ethyl esters of linear or branched C8-C10 fatty acids, tall oil fatty acid, trialkyl C2-C8 linear or branched phosphates, aromatic solvents, mineral oils, methyl benzoate, methyl salicylate, octyl acetates, octyl lactate, alkylnitriles, and combinations thereof.

In one embodiment, the composition comprises of the linear fatty acid and the additive.

In one embodiment, the composition consists essentially of the linear fatty acid and the additive.

In another embodiment, the composition consists of the linear fatty acid and the additive.

In a further embodiment, the composition comprises the linear fatty acid and the additive wherein the additive includes the alkoxylated phosphate ester surfactant and may or may not include the diluent.

In a further embodiment, the composition consists essentially of the linear fatty acid and the additive wherein the additive includes the alkoxylated phosphate ester surfactant and may or may not include the diluent.

In a further embodiment, the composition consists of the linear fatty acid and the additive wherein the additive includes the alkoxylated phosphate ester surfactant and may or may not include the diluent.

Alternatively, the composition comprises the linear fatty acid and the additive wherein the additive includes the diluent and may or may not include the alkoxylated phosphate ester surfactant.

Alternatively, the composition consists essentially of the linear fatty acid and the additive wherein the additive includes the diluent and may or may not include the alkoxylated phosphate ester surfactant.

Alternatively, the composition consists of the linear fatty acid and the additive wherein the additive includes the diluent and may or may not include the alkoxylated phosphate ester surfactant.

In one embodiment, the composition comprises pelargonic acid and an alkoxylated C12-C22 phosphate ester.

In one embodiment, the composition consists essentially of pelargonic acid and an alkoxylated C12-C22 phosphate ester.

In one embodiment, the composition consists of pelargonic acid and an alkoxylated C12-C22 phosphate ester.

In another embodiment, the composition comprises pelargonic acid and an alkoxylated triglyceride phosphate ester.

In another embodiment, the composition consists essentially of pelargonic acid and an alkoxylated triglyceride phosphate ester.

In another embodiment, the composition consists of pelargonic acid and an alkoxylated triglyceride phosphate ester.

In another embodiment, the composition comprises pelargonic acid and an alkoxylated alkylamine phosphate ester.

In another embodiment, the composition consists essentially of pelargonic acid and an alkoxylated alkylamine phosphate ester.

In another embodiment, the composition consists of pelargonic acid and an alkoxylated alkylamine phosphate ester.

In another embodiment, the composition comprises pelargonic acid and a diluent.

In another embodiment, the composition consists essentially of pelargonic acid and a diluent.

In another embodiment, the composition consists of pelargonic acid and a diluent.

In a further embodiment, the composition comprises pelargonic acid, a diluent, and an alkoxylated C12-C22 phosphate ester of the disclosure.

In a further embodiment, the composition consists essentially of pelargonic acid, a diluent, and an alkoxylated C12-C22 phosphate ester of the disclosure.

In a further embodiment, the composition consists of pelargonic acid, a diluent, and an alkoxylated C12-C22 phosphate ester of the disclosure.

In another embodiment, the composition comprises pelargonic acid, a diluent, and an alkoxylated triglyceride phosphate ester of the disclosure.

In another embodiment, the composition consists essentially of pelargonic acid, a diluent, and an alkoxylated triglyceride phosphate ester of the disclosure.

In another embodiment, the composition consists of pelargonic acid, a diluent, and an alkoxylated triglyceride phosphate ester of the disclosure.

In another embodiment, the composition comprises pelargonic acid, a diluent, and an alkoxylated alkylamine phosphate ester of the disclosure.

In another embodiment, the composition consists essentially of pelargonic acid, a diluent, and an alkoxylated alkylamine phosphate ester of the disclosure.

In another embodiment, the composition consists of pelargonic acid, a diluent, and an alkoxylated alkylamine phosphate ester of the disclosure.

In still another embodiment, the composition comprises pelargonic acid, another pesticide, and an alkoxylated phosphate ester of the disclosure.

In still another embodiment, the composition comprises pelargonic acid, another pesticide, a diluent, and an alkoxylated phosphate ester of the disclosure.

In another embodiment, the composition comprises pelargonic acid and an alkoxylated alkylamine phosphate ester.

In another embodiment, the composition consists essentially of pelargonic acid and an alkoxylated alkylamine phosphate ester.

In another embodiment, the composition consists of pelargonic acid and an alkoxylated alkylamine phosphate ester.

In another embodiment, the composition comprises pelargonic acid, a diluent, and an alkoxylated alkylamine phosphate ester of the disclosure.

In another embodiment, the composition consists essentially of pelargonic acid, a diluent, and an alkoxylated alkylamine phosphate ester of the disclosure.

In another embodiment, the composition consists of pelargonic acid, a diluent, and an alkoxylated alkylamine phosphate ester of the disclosure.

In another embodiment, the composition is a stable ready-to-use emulsion comprising at least one linear C5-C10 fatty acid, at least one phosphate ester of the disclosure, and water, wherein the concentration of the at least one C5-C10 fatty acid is about 2 wt % to about 15 wt %, about 3 wt % to about 12 wt %, or about 4 wt % to about 10 wt %, wherein the concentration of the at least one phosphate ester is about 0.1 wt % to about 2 wt % or about 0.4 wt % to about 1 wt %. and wherein the concentration of water is about 80 wt % to about 98 wt % or about 85 wt % to about 95 wt %, each based on a total weight of the emulsion. In various embodiments, the concentration of the at least one C5-C10 fatty acid is about 2, 3, 4, 5, 6, 7, 8, 9, 10, 11, 12, 13, 14, or 15 wt %, based on a total weight of the emulsion. In other embodiments, the concentration of the at least one phosphate ester is about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, or 2, wt %, based on a total weight of the emulsion. In other embodiments, the concentration of water is about 80, 81, 82, 83, 84, 85, 86, 87, 88, 89, 90, 91, 92, 93, 94, 95, 96, 97, or 98, wt %, based on a total weight of the emulsion. The terminology “consists essentially of” describes various embodiments that are typically free of one or more of pesticides, surfactants that are not the aforementioned surfactants, additives, solvents, water, adjuvants, etc. as chosen by one of skill in the art. In various non-limiting embodiments, all values and ranges thereof, both whole and fractional, including and between those set forth above are hereby expressly contemplated for use herein.

### Linear Fatty Acid:

Referring back, the linear fatty acid has a C5 to C10 alkyl chain. In various embodiments, the linear fatty acid has five, six, seven, eight, nine, or ten carbon atoms in an alkyl chain or includes a mixture of compounds that include eight, nine, or ten carbon atoms in an alkyl chain.

For example, the linear fatty acid may be pelargonic acid. Examples of commercial pelargonic acid are Matrilox AP001M (98%) from Matrica, Emerion W 90 PA (90%) from Emery Olechemicals, and Emery 1202 (90%) from BASF/Cognis. In some cases, a mixture of linear C8-C10 fatty acid (caprylic/capric acid) can alternatively be used or can be used with pelargonic acid. The term of pelargonic acid, nonanoic acid, and C9 acid are used interchangeably throughout the specification. The term of fatty acid, monocarboxylic acid are used interchangeably throughout the specification.

In various embodiments, the linear fatty acid is pelargonic acid and is present in an amount of from about 20 to about 95, about 35 to about 90, or about 50 to about 90, wt % actives based on a total weight of the composition. This amount may be about 25 to about 90, about 30 to about 85, about 35 to about 80, about 40 to about 75, about 45 to about 70, about 50 to about 65, or about 55 to about 60, wt % actives based on a total weight of the composition. The linear fatty acids can also be C5-C7 acids. They can be used alone or in combination with C8-C10 acids. When used together with pelargonic acid, C5-C7 acids function as adjuvants mainly by lowering melting point of the EC formulations. In this sense, C5-C7 acids can be described as diluents. The monocarboxylic acid(s) may be any known in the art to include 5, 6, 7, 8, or 9 carbon atoms. Some products include a mixture of C5-C9 monocarboxylic acids (and other minor impurities). Typical examples include Matrilox IL001M and Emery 1210. In various embodiments, the fatty acid is present in the composition in any one or more of the amounts described immediately above. In various non-limiting embodiments, all values and ranges thereof, both whole and fractional, including and between those set forth above are hereby expressly contemplated for use herein.

### Additive:

Referring now to the additive, the additive is chosen from a diluent, an alkoxylated phosphate ester surfactant, and combinations thereof. For example, the additive may include the diluent. Alternatively, the additive may include the alkoxylated phosphate ester surfactant. Alternatively, the additive may include the diluent and the alkoxylated phosphate ester surfactant. Moreover, the additive may include the diluent and be free of the alkoxylated phosphate ester surfactant. Alternatively, the additive may include the alkoxylated phosphate ester surfactant and be free of the diluent.

In various embodiments, the additive is present in the composition in an amount of from about 5 to about 80, about 8 to about 60, or about 10 to about 40, weight percent actives based on a total weight of the composition. In various embodiments, this amount is from about 10 to about 75, about 15 to about 70, about 20 to about 65, about 25 to about 60, about 30 to about 55, about 35 to about 50, or about 40 to about 45, weight percent actives based on a total weight of the composition. In various non-limiting embodiments, all values and ranges thereof, both whole and fractional, including and between those set forth above are hereby expressly contemplated for use herein.

### Diluent:

Referring to the diluent, the composition may include, or be free of, one or more diluents. For example, in one embodiment that utilizes pelargonic acid, and because pelargonic acid has a melting point of about 12° C.-14° C., the composition may desirably contain diluents (or solvents) that can lower the melting point of the pelargonic acid. In various embodiments, the diluent preferably provides adjuvancy to pelargonic acid. In order to lower the pelargonic acid melting point effectively, a suitable diluent typically has a melting point less than about 5, 0, -5, or −10, ° C. The extent of pelargonic acid melting point lowering typically depends on the concentration of the added diluents. In various embodiment, the melting point of the composition as a whole may be less than about 5, 0, −5, or −10, ° C. In various non-limiting embodiments, all values and ranges thereof, both whole and fractional, including and between those set forth above are hereby expressly contemplated for use herein.

In various embodiments, the diluent is chosen from C4-C10 linear or branched alcohols and their propoxylates, branched C5-C10 monocarboxylic acids, methyl and ethyl esters of linear or branched C8-C10 fatty acids, tall oil fatty acid, trialkyl C2-C8 linear or branched phosphates, aromatic solvents, mineral oils, methyl benzoate, methyl salicylate, octyl acetates, octyl lactate, alkylnitriles, cyclic monoterpene (such as d-limonene), and combinations thereof. More typically, a diluent can be chosen from 2-ethyhexanoic acid (2-EH acid), 2-ethylhexanol (2-EH alcohol), hexanol, and combinations thereof. The diluent may include any one or more of these compounds with, or to the exclusion of, any one or more of the other compounds. In various embodiments, the diluent is chosen from C4-C10 linear or branched alcohols and their propoxylates, C5-C10 branched monocarboxylic acids, and tall oil fatty acid. All combinations of these compounds alone, in combination with one or more of the other compounds, and to the exclusion of one or more of the other compounds, are hereby expressly contemplated for use in various non-limiting embodiments.

In various embodiments, the diluent is, includes, or is free of, one or more of C4-C10 linear or branched alcohols and their propoxylates. These alcohols may be or include any alcohols that have 4, 5, 6, 7, 8, 9, or 10 carbon atoms, or any range of values including and between those values. Carbon atoms may be present as alkyl, alkenyl, or alkynyl, groups in any linear or branched isomeric configurations known in the art, all of which are expressly contemplated for use herein. Typical examples of such alcohols include butanol, hexanol, octanol, decanol, 2-EH alcohol, 2-propylheptanol, Exxal 8, Exxal 9, and Exxal 10.

In various embodiments, the diluent is, includes, or is free of, one or more branched C5-C10 monocarboxylic acids. These carboxylic acids may be or include any that have 5, 6, 7, 8, 9, or 10 carbon atoms, or any range of values including and between those values. All isomers are hereby expressly contemplated for use herein in various non-limiting embodiments. Typical examples of such carboxylic acids include 2-EH acid and neodecanoic acid.

In other embodiments, the diluent is, includes, or is free of, one or more of methyl and/or ethyl esters of linear or branched C5-C10 monocarboxylic acids. These carboxylic acids may be or include any that have 5, 6, 7, 8, 9, or 10 carbon atoms, or any range of values including and between those values. All isomers are hereby expressly contemplated for use herein in various non-limiting embodiments. A typical example of such fatty acid esters is CE-810K that is commercially available from Proctor & Gamble.

In various embodiments, the diluent is free of oleic acid, tall oil fatty acid, or combinations thereof. In another embodiment, the diluent is tall oil fatty acid.

In other embodiments, the diluent is, includes, or is free of, one or more trialkyl C2-C8 linear or branched phosphates. The alkyl groups of these phosphates may include any that have 2, 3, 4, 5, 6, 7, or 8 carbon atoms, or any range of values including and between those values. Typical examples include triethyl phosphate, tributyl phosphate, and trioctyl phosphate.

In various embodiments, the diluent includes, or is free of, aromatic solvents. The aromatic solvents are not particularly limited and may be any known in the art. The aromatic solvent may be an aromatic hydrocarbon. Suitable non-limiting examples of the aromatic solvent include solvent naphtha (petroleum), heavy aromatic, solvent naphtha (petroleum), light aromatic, C9-C10 aromatic hydrocarbon solvent, and mixtures of two or more thereof, optionally with additional components. Typical examples of industrial aromatic hydrocarbons include Aromatic 100, Aromatic 150, Aromatic 200, Solvesso 100, Solvesso 150, Solvesso 150 ND, Solvesso 200 and Solvesso 200 ND available from ExxonMobil, Shellsol X7B, Shellsol A100, Shellsol A150 and Shellsol A150ND, available from Shell Chemicals, and Farbasol, available from Orlen Oil.

In various embodiments, the diluent includes, or is free of, methyl benzoate, methyl salicylate, octyl acetates, octyl lactate, or combinations thereof. For example, in one embodiment, the diluent includes or is, or is free of, methyl benzoate. In another embodiment, the diluent includes or is, or is free of, methyl salicylate. In another embodiment, the diluent includes or is, or is free of, octyl acetates. In another embodiment, the diluent includes or is, or is free of, octyl lactate. In another embodiment, the diluent includes or is, or is free of, combinations of two or more of the above.

In various embodiments, the diluent is present in an amount of greater than zero and less than about 80, about 50, or about 30, wt % actives based on a total weight of the composition. This amount may be less than about 1, 2, 3, 4, 5, 10, 15, 20, 25, 30, 35, 40, 45, 50, 55, 60, 65, 70, or about 75, wt % actives based on a total weight of the composition. In other embodiments, this amount may be from about 5 to about 75, about 10 to about 70, about 15 to about 65, about 20 to about 60, about 25 to about 55, about 30 to about 50, about 35 to about 45, or about 40 to about 45, wt % actives based on a total weight of the composition. In various non-limiting embodiments, all values and ranges thereof, both whole and fractional, including and between those set forth above are hereby expressly contemplated for use herein.

In one embodiment, the composition is free of the diluent and comprises the alkoxylated phosphate ester. In another embodiment, the diluent is present and is chosen from 2-ethyhexaonic acid, tall oil fatty acid, 2-ethyhexanol, hexanol, and combinations thereof. In another embodiment, the diluent is present and is chosen from d-limonene, mineral oil, and combinations thereof. In another embodiment, the composition is free of the alkoxylated phosphate ester and comprises the diluent.

### Alkoxylated Phosphate Ester:

The additive may alternatively be, include, or be free of, an alkoxylated phosphate ester. This phosphate ester may be any known in the art. The terminology “alkoxylated” used throughout the instant disclosure may describe methoxylated, ethoxylated, propoxylated, butoxylated, etc., as is known in the art. Moreover, all isomers are hereby expressly contemplated for use herein in various non-limiting embodiments. The number of carbon atoms in the alkoxylating moiety is not particularly limited and may include 1, 2, 3, or 4. In various non-limiting embodiments, all values and ranges thereof, both whole and fractional, including and between those set forth above are hereby expressly contemplated for use herein.

In various embodiments, the alkoxylated phosphate ester surfactant has a degree of alkoxylation of from about 10 to about 100. In other words, the phosphate ester typically is alkoxylated with from about 10 to about 100 moles of an alkylene oxide such as ethylene oxide, propylene oxide, butylene oxide, or combinations thereof. In various embodiments, the degree of alkoxylation is from about 10 to about 44, about 15 to about 50, about 20 to about 45, about 25 to about 40, about 30 to about 35, about 12 to about 36, about 14 to about 34, about 16 to about 32, about 18 to about 30, about 20 to about 28, about 22 to about 26, about 24 to about 26, about 15 to about 23, about 16 to about 22, about 17 to about 21, about 18 to about 20, about 19 to about 20, about 15 to about 40, about 20 to about 35, about 25 to about 30, about 20 to about 36, about 22 to about 34, about 24 to about 32, about 26 to about 30, or about 28 to about 30. In various non-limiting embodiments, all values and ranges thereof, both whole and fractional, including and between those set forth above are hereby expressly contemplated for use herein.

In other embodiments, the phosphate ester is chosen from alkoxylated C12-C22 alkyl phosphate esters, alkoxylated phosphate esters formed from an alkoxylated triglyceride having at least one pendant hydroxyl group, an alkoxylated phosphate ester formed from an alkoxylated alkylamine, and combinations thereof. For example, the phosphate ester may be any alkoxylated alkyl phosphate ester wherein the alkyl group has 12, 13, 14, 15, 16, 17, 18, 19, 20, 21, or 22 carbon atoms. In various embodiments, the range of carbon atoms is 12 to 22, 13 to 21, 14 to 20, 15 to 19, 16 to 18, 16 to 18, 12 to 14, 12 to 16, 12 to 18, 12 to 20, 12 to 22, 14 to 16, 14 to 18, 14 to 20, 14 to 22, 16 to 18, 16 to 20, 16 to 22, 18 to 20, 18 to 22, or 20 to 22. The alkyl group may be linear or branched. All isomers thereof are hereby expressly contemplated for use in various non-limiting embodiments. Typical examples include lauryl, tridecyl, cetyl, stearyl, and erucyl. In various non-limiting embodiments, all values and ranges thereof, both whole and fractional, including and between those set forth above are hereby expressly contemplated for use herein.

Referring to the alkoxylated phosphate esters formed from an alkoxylated triglyceride having at least one pendant hydroxyl group, this compound may also be any known in the art. The alkoxylation may be as described above. Moreover, the triglyceride itself is not particularly limited any may be any known in the art. The triglyceride may be described as a tri-ester including glycerol bound to three fatty acid molecules wherein each fatty acid molecule or chain has from 14 to 22 carbon atoms. Naturally only castor oil triglyceride has pendant hydroxyl groups. However, other triglycerides with double bonds can also have pedant OH groups since the double bonds can be epoxidized and hydrolyzed into pedant OH groups. Typically, each chain independently has from 14 to 22, 14 to 20, 18 to 22, 20 to 22, 16 to 20, 16 to 18, or 18 to 20, carbon atoms. Each chain may independently include, or be free of, one or more pendant hydroxyl groups and one or more carbon-carbon double bonds. Typical examples of the triglycerides having at least one pendant hydroxyl group include castor oil alkoxylates and alkoxylates derived from epoxidized soy oil. In various non-limiting embodiments, all values and ranges thereof, both whole and fractional, including and between those set forth above are hereby expressly contemplated for use herein.

In other embodiments, referring to the alkoxylated phosphate esters formed from an alkoxylated alkylamine, this compound is known in the art. The alkoxylation and alkyl group may be as described above. Typical examples of alkylamine include coco amine, lauryl amine, palm amine, soya amine, tallow amine, stearyl amine, oleyl amine, and rapeseed amine.

In various embodiments, the alkoxylated phosphate ester surfactant is a mixture of mainly mono and di phosphate esters. They may have the following general formulas:

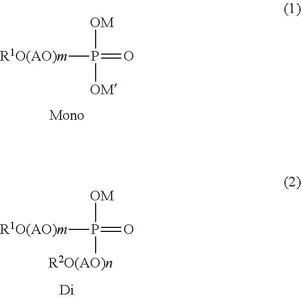

wherein each of M and M′ are independently chosen from a hydrogen atom (H) or a cation; (AO) is an alkoxy group; and each of R¹ and R² are independently chosen from:
(a) an alkyl hydrocarbon as described above, (e.g. saturated or unsaturated, branched or linear) group having from 12 to 22 carbon atoms; wherein each of m and n are independently from about 10 to about 100;
(b) an alkoxylated triglyceride group wherein the triglyceride is derived from castor oil or an epoxidized/hydrolyzed triglyceride. One example of the triglyceride group is:

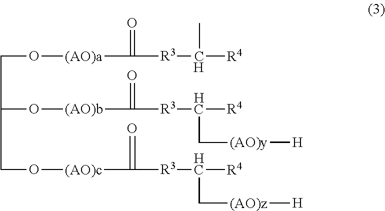

where R³ and R⁴ are hydrocarbon groups when the triglyceride is from castor oil, and when the triglyceride is from an epoxidized triglyceride, R⁴ is
where R⁵ is a hydrocarbon group,

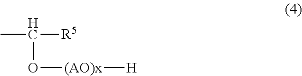

and wherein each of m, n, a, b, c, x, y, and z individually can be 0 or any value such that m +a+b+c+x+y+z and n+a+b+c+x+y+z is less than about 100, 95, 90, 85, 80, 75, 70, 65, 60, 55, 50, 45, 40, 35, 30, 25, 20, 15, 10, or 5, or less.

Since both alkoxylated triglyceride and phosphating agent have more than one reactive hydroxyl groups, it is possible to form an oligomer or a polymer;
(c) an alkoxylated alkylamine group having from about 12 to 22 carbon atoms; wherein each of m and n are defined previously. One example of the alkoxylated alkylamine group has the general formula:

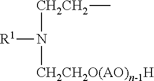

wherein R¹ is as described above. Since both alkoxylated alkylamine phosphating agent have more than one reactive hydroxyl group, it is possible to form an oligomer or a polymer. In various non-limiting embodiments, all values and ranges thereof, both whole and fractional, including and between those set forth above are hereby expressly.

The AO group refers to an alkoxy group which may be any described above.

The alkoxylated phosphate esters can be made by methods well-known in the art. Examples of synthesizing phosphate esters are disclosed in various publications including (1) U.S. Pat. No. 3,346,670, (2) WO2019162353A, (3) WO200111958, (4) Journal of Surfactants and Detergents volume 5, pages 169-172(2002) and references therein, and (5) Tenside Surfactants Detergents 55(4):266-272, July 2018 (DOI: 10.3139/113.110570) and references therein, each of which are hereby expressly incorporated by reference herein in various non-limiting embodiments. Typically, the alkoxylated phosphate esters include a majority of mono-alkyl phosphate ester and di-alkyl phosphate ester, some unreacted starting C12-C22 alcohol alkoxylates, castor oil alkoxylates, or alkylamine alkoxylates, and some phosphoric acid.

The alkoxylated phosphate esters can be made by reacting a C12-C22 alcohol alkoxylate, a triglyceride alkoxylate having at least one pendant hydroxyl group, or a alkylamine alkoxylate with P2O5, polyphosphoric acid (PPA), or both. Each can be in acid form, neutralized or partially neutralized forms with various neutralizing bases. The alkoxylated phosphate esters can also be made by reacting a mixture formed from the group of C12-C22 alcohol alkoxylates, triglyceride alkoxylates having at least one pedant hydroxyl group, and alkylamine alkoxylates.

In various embodiments, the alkoxylated phosphate ester has an alcohol group with a chain length of from C12-C18. More typically, the alcohol is predominately C12-16, C13 branched, cetyl (C16), or stearyl (C18), or mixture of cetyl and stearyl.

When the alkoxylated phosphate ester is formed from a triglyceride alkoxylate having at least one pendant hydroxyl group, the typical triglycerides are castor oil and epoxidized triglycerides. More typically, the triglyceride is castor oil.

When the alkoxylated phosphate ester is formed from an alkylamine alkoxylate, the alkyl chain length typically is C12-C22. More typically, the alkyl chain length is C12-C18. such as those derived from triglycerides of coco, palm, tallow, soy, canola, corn, sunflower, and rapeseed.

The typical alkoxylate group in the alkoxylated phosphate esters of the disclosure is an ethoxylate group (EO). EO number typically is between about 10 and about 100, more typically between about 12 and about 64, and most typically from about 15 and about 30. In various non-limiting embodiments, all values and ranges thereof, both whole and fractional, including and between those set forth above are hereby expressly contemplated for use herein.

In one embodiment, the alkoxylated alkyl phosphate ester is present and is chosen from an alkoxylated branched C13 alkyl phosphate ester, an alkoxylated linear C12-C16 alkyl phosphate ester, an alkoxylated linear C16-C18 alkyl phosphate ester, and combinations thereof. In another embodiment, the alkoxylated phosphate ester is present and is formed from an alkoxylated triglyceride chosen from alkoxylated castor oil, alkoxylated epoxidized triglycerides, and combinations thereof. In a further embodiment, the alkoxylated phosphate ester is present and is formed from an alkoxylated tallowamine. In a further embodiment, the alkoxylated phosphate ester is present and is ethoxylated to a degree of ethoxylation of from about 10 to about 100, about 12 to about 60, from about 15 to about 60, or from about 12 to about 30. In various non-limiting embodiments, all values and ranges thereof, both whole and fractional, including and between those set forth above are hereby expressly contemplated for use herein.

In various embodiments, the alkoxylated phosphate ester is present and is formed using a starting molar equivalent ratio of phosphating agent to hydroxyl group of from about 1:3 to about 1:1, for example about 1:1.5, 1:2, 1:2.5. The phosphating agent may be any known in the art or described herein. In various non-limiting embodiments, all values and ranges thereof, both whole and fractional, including and between those set forth above are hereby expressly contemplated for use herein.

In other embodiments, the alkoxylated phosphate ester is present and comprises a molar ratio of mono- to di-phosphate esters of from about 12:1 to about 1:1. The mono- and di-esters are chosen based on the specific chemistry described above, as is well known in the art. In various embodiments, the ratio is about 16:1, 11.5:1, 11:1, 10.5:1, 10:1, 9.5:1, 9:1, 8.5:1, 8:1, 7.5:1, 7:1, 6.5:1, 6:1, 5.5:1, 5:1. 4.5:1, 4:1, 3.5:1, 3:1. 2.5:1, 2:1, or 1.5:1. In various non-limiting embodiments, all values and ranges thereof, both whole and fractional, including and between those set forth above are hereby expressly contemplated for use herein.

In other embodiments, the alkoxylated phosphate ester is present and comprises less than about 40, 35, 30, 25, 20, 15, 10, or 5, wt % actives of unreacted alkoxylated alcohol, alkoxylated triglyceride, or alkoxylated alkylamine, based on a total weight of the alkoxylated phosphate ester. In various non-limiting embodiments, all values and ranges thereof, both whole and fractional, including and between those set forth above are hereby expressly contemplated for use herein.

In various embodiments, the alkoxylated phosphate ester is present in an amount from greater than about zero up to about 40, from about 5 to about 30, or from about 8 to about 20, wt % actives based on a total weight of the composition. For example, this amount may be about, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 wt % actives based on a total weight of the composition. In various non-limiting embodiments, all values and ranges thereof, both whole and fractional, including and between those set forth above are hereby expressly contemplated for use herein.

### Supplemental Additives:

In various embodiments, one or more supplemental additives (that are different from the aforementioned additive) are also included in the composition. For example, in one embodiment, the composition includes a second surfactant different from the alkoxylated phosphate ester surfactant. The second surfactant is not particularly limited and may be any anionic, cationic, non-ionic, and/or amphoteric/zwitterionic surfactant known in the art. In various embodiments, the second surfactant is chosen from alkylbenzene sulfonic acids such as dodecylbenzene sulfonic acid and their isopropylamine salts, isopropylamine salts of a C8-C10 linear or branched carboxylic acids, isopropylamine salts of tall oil fatty acid, alkylamine alkoxylates, alcohol ethoxylates, and combinations thereof.

In various embodiments, the second surfactant is chosen from alkylbenzene sulfonic acids (and their salts); amine salts of C8-C10 linear or branched carboxylic acids, and tall oil fatty acid (TOFA); alkylamine alkoxylate (for examples, Ethomeen SV/25 and Ethomeen C/12), alcohol alkoxylates; castor oil ethoxylates; polyethylene glycol sorbitan monolaurate (for example, Tween 20) and POE (20) sorbitan monooleate (for example Tween 80); polyoxyethylene Sorbitol Tallate; and alkylpolyglucoside (for examples AG 6210, Agnique PG-9116). Preferably the second surfactant is chosen from isopropylamine salt of alkylbenzene sulfonate (e.g., dodecylbenzene sulfonate), isopropylamine salts of C8-C10 linear or branched carboxylic acids, isopropylamine salts of tall oil fatty acid (TOFA), and alcohol ethoxylate.

In other embodiments, the supplemental additive includes a base. Any base known in the art can be used. For example, the base may be an organic or inorganic base such as a metal hydroxide. In various embodiments, the base is chosen from isopropylamine (IPA), dimethylamidopropylamine (DMAPA), monoethanolamine, ammonium hydroxide, and combinations thereof.

Alternatively, the supplemental additive may be or include a preservative, colorant, odor-marking agent, a defoamer, water, or combinations thereof.

Pesticide and/or Growth Inhibitor:

In other embodiments, the composition includes, or is combined with, a pesticide and/or a growth inhibitor that is different from the linear fatty acid. In various embodiments, the pesticide is a liquid pesticide and it may be chosen from phenoxyl herbicides such as 2,4-D octyl ester and MCPA, benzoic acid herbicides such as dicamba, chloroacetanilide herbicides such as acetochlor, cyclohexene oxime herbicides such as clethodim, aliphatic organothiophosphate insecticides such as malathion, thiadiazole fungicides such as etridiazole, thiocarbamate herbicides such as cycloate, and combinations thereof. In other embodiments, the pesticide and/or growth inhibitor is a solid with adequate solubility in the linear C5-C10 fatty acids with or without a diluent and the solid pesticide and/or the growth inhibitor may be chosen from 2,4-D acid, dicamba acid, an imidazolinone herbicide such as imazapyr and imazethapyr, maleic hydrazide, or combinations thereof.

### Additional Embodiments:

In various embodiments, the composition includes pelargonic acid, one or more alkoxylated phosphate esters, and a diluent. In other embodiments, the concentration of pelargonic acid in the composition is from about 20 to about 95, about 35 to about 90, or about 50 to about 90, weight percent actives based on a total weight of the composition. In other embodiments, this concentration is from about 25 to about 90, about 30 to about 85, about 35 to about 80, about 40 to about 75, about 45 to about 70, about 50 to about 65, or about 55 to about 60, weight percent actives based on a total weight of the composition. In various related embodiments, the concentration of the alkoxylated phosphate esters in the composition is from about 0 to about 40, greater than about 0 and up to about 30, about 5 to about 40, about 5 to about 30, about 8 to about 20, or about 10 to about 15, weight percent actives based on a total weight of the composition. In still other related embodiments, the concentration of the diluent in the composition is less than about 80, 75, 70, 65, 60, 55, 50, 45, 40, 35, 30, 25, 20, 15, 10, or 5, weight percent actives based on a total weight of the composition. In various non-limiting embodiments, all values and ranges thereof, both whole and fractional, including and between those set forth above are hereby expressly contemplated for use herein.

### Emulsifiable Concentrate:

In other embodiments, when the composition comprises linear C5-C10 fatty acids and a surfactant with or without a diluent, the composition can be described as an emulsifiable concentrate (EC). When an EC is diluted into water, it is able to form an emulsion with gentle agitation. The EC typically has good bloom (i.e., the ability to form emulsion when adding to water without excessive agitation) and acceptable stability, as understood by those of skill in the art. In various embodiments, acceptable emulsions generally do not flocculate in about 24 hours. In various embodiments, an emulsion has less than about 2% separation as measured based on top cream or sediment, as is appreciated by those of skill in the art, after about 24 hours. In some embodiments, a 2-hour emulsion stability with about 2-3% cream is acceptable. If cream or sediment is formed, bulk emulsion whiteness can remain acceptable and the emulsion may be able to go back to its original form with gentle agitation or mixing.

In various embodiments, an EC has acceptable properties when made using water having a hardness from about 34 ppm (soft water) to about 1000 ppm (hard water) of minerals. However, emulsion properties (e.g. bloom and separation) of an EC may vary with water hardness.

The composition may be a clear solution or a slightly hazy product as long as the composition or EC does not separate during storage. Depending on geological locations, an acceptable composition should be stable between about 10° C. and about 54° C., typically about 0° C. and about 54° C., more typically about −10° C. and about 54° C., and most typically about −20° C. and about 54° C. In various non-limiting embodiments, all values and ranges thereof, both whole and fractional, including and between those set forth above are hereby expressly contemplated for use herein.

The composition can be applied as is without diluting into water. The composition can be used in backpack sprayers, tractor sprayers, or drone sprayers without dilution into water. However, when the composition is an EC, it is desirably diluted into water before use. Typically it is diluted to 1-10% C9 acid equivalent depending on weed species. In various non-limiting embodiments, all values and ranges thereof, both whole and fractional, including and between those set forth above are hereby expressly contemplated for use herein.

One embodiment provides a high load EC with >about 60 wt % actives pelargonic acid. Another embodiment provides a high load EC with 80% or more active pelargonic acid.

A formulation with higher loading saves costs for packaging, storage, and shipping. In addition, if a formulation has higher loading, end users, when going to stores, do not have to purchase a large quantity of the formulations, leaving room for other supplies.

One embodiment provides a stable pelargonic EC comprising less than about 20wt % actives of total emulsifiers comprising alkoxylated phosphate ester of the disclosure.

One embodiment provides a stable pelargonic EC with the alkoxylated phosphate ester of the disclosure and a melting point lowering diluent wherein the combination of the alkoxylated phosphate ester and the diluent is able to offer adjuvancy to pelargonic acid.

One embodiment provides a stable pelargonic EC that can be tank-mixed with various tank-mix additives.

One embodiment provides a pesticide composition comprising pelargonic acid, a liquid pesticide, and an alkoxylated phosphate esters of the disclosure.

### Tank-Mix Composition:

This disclosure also provides a tank-mix composition which includes the aforementioned agrochemical composition and a tank-mix additive. The tank-mix additive is not particularly limited and may be any known in the art. In various embodiments, the tank-mix additive is chosen from ammonium sulfate, potassium sulfate, ammonium nitrate, drift control agents, and pesticide formulations. Typical tank-mix additives are ammonium sulfate, and aqueous pesticide formulations comprising glyphosate, glufosinate, and dicamba. Method:

The disclosure further provides a method comprising the steps of providing the agrochemical composition and applying the composition to a target which may be any plant, crop, pest, etc. In one embodiment, the composition is not diluted with water before the step of applying. However, in the alternative, the composition may be diluted with water before the step of applying.

### EXAMPLES

### Phosphate Ester Samples

Various alkoxylated phosphate ester samples were made using well-known methods. Starting alkoxylates were reacted with phosphating agents. The phosphating agent used was P2O5, polyphosphoric acid (PPA), or PPA followed by P2O5 to convert residual starting alcohol ethoxylate. The molar ratio of alkyl alcohol ethoxylate to phosphating agent was between 1:1 and 3:1. The molar ratio of castor oil ethoxylate to phosphating agent was 1:3 (i.e., ROH:phosphating agent=1:1). The molar ratio of tallowamine ethoxylate to phosphating agent was 1:2 (i.e., ROH:phosphating agent=1:1). The samples may use water (a few wt %) to hydrolyze pyrophosphate, unreacted P2O5, or PPA to phosphoric acid. Generally the emulsification performance is not affected by this final hydrolysis step.

| | | | R-EO to | | | | |
|---|---|---|---|---|---|---|---|
| | Starting | Phosphating | phosphating | R-EO | H₃PO₄ | MAP | DAP |
| PE ID | alc-EO | agent | agent ratio | mol % | mol % | mol % | mol % |
| PE1^{a} | C1216 + | P2O5 | 2 to 1 | | | | |
| | 15 EC | | | | | | |
| PE2^{b} | C1216 + | P2O5 | 2 to 1 | | | | |
| | 30 EC | | | | | | |
| PE3 | C1618 + | PPA | 1 to 1 | 31.3 | 19.1 | 43.7 | 4.2 |
| | 20 EO | | | | | | |
| PE4 | C1618 + | PPA | 1 to 1 | 3.4 | 28.8 | 52.6 | 12.8 |
| | 23EO | | | | | | |
| PE5 | Exxal 13 + | PPA | 1 to 1 | 1.9 | 26.4 | 58 | 11.4 |
| | 15 EO | | | | | | |
| PE6 | Exxal 13 + | P2O5 | 2 to 1 | | | | |
| | 20 EO | | | | | | |
| PE7 | Exxal 13 + | P2O5 | 1.9 to 1 | 24.1 | 5.5 | 44.8 | 23.3 |
| | 15 EO | | | | | | |
| PE8 | Exxal 13 + | P2O5 | 1.9 to 1 | 24.1 | 5.5 | 44.8 | 23.3 |
| | 15 EO | | | | | | |
| PE9 | Exxal 13 + | P2O5 | 2 to 1 | 0 | 17.1 | 47.7 | 27.7 |
| | 15 EO | | | | | | |
| PE10 | Exxal 13 + | P2O5 | 2.5 to 1 | 11.7 | 7.3 | 53 | 27.1 |
| | 15 EO | | | | | | |
| PE12 | Exxal 13 + | P2O5 | 3 to 1 | 25.2 | 8.1 | 39.4 | 25.2 |
| | 15 EO | | | | | | |
| PE13-pre | C1618 + | PPA | 1.4 to 1 | 35.2 | 24.2 | 21.3 | 8.1 |
| | 20EO | | | | | | |
| PE13 | C1618 + | P2O5 | 3 to 1 | 4.8 | 20.4 | 61.8 | 9.9 |
| | 20EO PE | | | | | | |
| PE14 | Exxal 13 + | P2O5 | 2.67 to 1 | | 10 | 50.8 | 32 |
| | 5.6PO + | | | | | | |
| | 12.8EO | | | | | | |
| PE15 | C1618 + | PPA | 1 to 1 | 0.6 | 29.3 | 55.2 | 10.1 |
| | 20EO | | | | | | |
| PE16 pre | C1618 + | PPA | 1.4 to 1 | 41.7 | 25.6 | 22.6 | 2.4 |
| | 20EO | | | | | | |
| PE16 | C1618 + | P2O5 | 3 to 1 | 4 | 0 | 80.8 | 13 |
| | 20EO | | | | | | |
| PE17 | C1618 − | PPA | 1 to 1 | 4.2 | 20 | 60.8 | 4 |
| | 5PO − 19EO | | | | | | |
| PE18 | C1618 + | PPA | 1 to 1 | 0 | 24.5 | 60 | 10 |
| | 23EO | | | | | | |
| PE19 | C1618 + | P2O5 | 3 to 1 | 21 | 10 | 42.5 | 22.9 |
| | 23EO | | | | | | |
| PE20 | Emulpon | PPA then | 9.9 to 7 to 1 | ~0 | | | |
| | CO-360 | P2O5 | | | | | |
| PE21 | Emulpon | PPA | 1 to 1 | | 28.6 | 48.5 | 3.1 |
| | CO-360 | | | | | | |
| PE22 | Emulpon | PPA | 1 to 1 | | 37.5 | 41.6 | 2.4 |
| | CO-200 | | | | | | |
| PE23 | Tallow | PPA | 1 to 1 | | 51 | 44 | |
| | amine- | | | | | | |
| | 40EO | | | | | | |
| PE24 | Exxal-13- | P2O5 | 2.7 to 1 | | | | |
| | 2.5PO − | | | | | | |
| | 14EO | | | | | | |

^{a}Total acidity = 1.35 meq/g, Strong Acidity = 0.81 meq/g, H3PO4 = 0.085 meq/g, MAP = 0.45 meq/g, DAP = 0.26 meq/g, Water = 20 wt %, clear at room temperature.
^{b}Total acidity = 1.35 meq/g, Strong Acidity = 0.81 meq/g, H3PO4 = 0.135 meq/g, MAP = 0.28 meq/g, DAP = 0.10 meq/g, Water = 20 wt %, flowable at 25 C.
The wt % of H3PO4 in a sample is typically about 10 times less than the mol % in the sample.

Emulpon CO-360 is a castor oil ethoxylate with about 36-44 EO groups. Emulpon CO-200 is a castor oil ethoxylate with about 20 EO groups.

All samples are solid or a paste at room temperature except the phosphate esters of castor oil ethoxylate (PE20, PE21, and PE22), PE1 (containing ˜20% water added after reaction), PE14, PE17, and PE24. PE2 has ˜17% water added after reaction. If the products are treated with a final hydrolysis step, the products may contain a few weight percent of water.

### Commercial Pelargonic Acid ECs

Comparative examples of emulsions are formed using commercial products. For example, Scythe and Beloukha, are used as comparative examples. To the best knowledge, Scythe contains 57% C9 acid, 3% other fatty acids, 30% petroleum mineral oil, and 10% emulsifiers. Beloukha contains 51.9% C9 acid and other undisclosed ingredients. Scythe and Beloukha were diluted in water of various hardness at various concentrations and the resulting emulsions were observed. The emulsions were in a long emulsion tube (˜400 mm). After adding the product to water, the emulsion tube was inverted for 10˜15 times. The emulsion results are shown below.

| | | | Cream or oil out amount, % volume | | | 24 hrs bulk |
|---|---|---|---|---|---|---|
| Comparative | Water | | 0.5 | 2 | 16-24 | emulsion |
| Example | Hardness | | hr | hrs | hrs | whiteness |
| 5% | 34 | ppm | 1 | 4 | 6 | Very Good |
| Scythe | 343 | ppm | 1 | 4 | 6 | Very Good |
| | 1000 | ppm | 2 | 4 | 6 | Very Good |
| 6% | 34 | ppm | <1 | 1 | 4 | Very Good |
| Beloukha | 343 | ppm | 5 (poor emulsion) | Failed | | Water-like (failed) |
| | 1000 | ppm | 6 (poor emulsion) | Failed | | Water-like (failed) |
| 16.66% | Tap water | | <1 | 13 | 25 | Good |
| Scythe | | | | | | |

| | | | | | |
|---|---|---|---|---|---|
| 19.34% | Tap water | 1 | 1 | 10 | Good |
| Beloukha | | | | (oil out) | |

The data show that the emulsion performance of commercial benchmarks is not ideal. In the case of Beloukha, the emulsions in medium-hard (342 ppm) and hard water (1000 ppm) were not acceptable.

### Example 1

### Diluents for Pelargonic Acid

Hexanol is Alfol 6 from Sasol. CE-810K, C8-C10 methyl ester, is from P&G. Sylfat 2LT is from Kraton. Aromatic 200 and Isopar L are from ExxonMobil Chemicals. Pelargonic acid (C9 acid) is either purchased from Sigma-Aldrich (97%) or obtained from Matrica (Matrilox AP001M, 98%) or Emery Oleochemicals (Emerion W 90 PA, 90%). The other chemicals are purchased from Sigma-Aldrich.

The following diluents are evaluated to determine whether each can lower the melting point of pelargonic acid. The terminology “crystal” means that crystals of pelargonic acid were visually observed. “Clear” means that the solution was clear as visually observed.

| Pelargonic | | Diluent | | |
|---|---|---|---|---|
| acid wt % | Diluent | wt % | −20° C. | 0° C. |
| 80 | 2-EH acid | 20 | Crystal | Crystal |
| 70 | 2-EH acid | 30 | Crystal | Clear |
| 60 | 2-EH acid | 40 | Crystal | Clear |
| 50 | 2-EH acid | 50 | Crystal | Clear |
| 30 | 2-EH acid | 70 | Clear | Clear |
| 80 | 2-EH alcohol | 20 | Crystal | Crystal |
| 70 | 2-EH alcohol | 30 | Crystal | Clear |
| 60 | 2-EH alcohol | 40 | Crystal | Clear |
| 50 | 2-EH alcohol | 50 | Crystal | Clear |
| 30 | 2-EH alcohol | 70 | Clear | Clear |
| 80 | Hexanol | 20 | Crystal | Crystal at 5° C. |
| | | | | clear at 10° C. |
| 70 | Hexanol | 30 | Crystal | Clear |
| 50 | Hexanol | 50 | Crystal | Clear |
| 30 | Hexanol | 70 | Clear | Clear |
| 80 | 2-EH | 20 | Crystal | Crystal |
| | alcohol:hexanol = 1:1 | | | |
| 60 | 2-EH | 40 | Crystal | Clear |
| | alcohol:hexanol = 1:1 | | | |
| 75 | Butyl Acetate | 25 | Crystal | Clear |
| 70 | Butyl Acetate | 30 | Crystal | Clear |
| 65 | Butyl Acetate | 35 | Crystal | Clear |
| 50 | Butyl Acetate | 50 | Crystal | Clear |
| 30 | Butyl Acetate | 70 | Clear | Clear |
| 75 | d-limonene | 25 | Crystal | Crystal |
| 70 | d-limonene | 30 | Crystal | Clear |
| 65 | d-limonene | 35 | Crystal | Clear |
| 50 | d-limonene | 50 | Crystal | Clear |
| 30 | d-limonene | 70 | Clear | Clear |
| 75 | Methyl salicylate | 25 | Crystal | Crystal |
| 70 | Methyl salicylate | 30 | Crystal | Crystal |
| 65 | Methyl salicylate | 35 | Crystal | Clear |
| 50 | Methyl salicylate | 50 | Crystal | Clear |
| 75 | Octyl lactate | 25 | Crystal | Crystal |
| 70 | Octyl lactate | 30 | Crystal | Crystal |
| 65 | Octyl lactate | 35 | Crystal | Crystal |
| 50 | Octyl lactate | 50 | Crystal | Clear |
| 30 | Octyl lactate | 70 | Crystal | Clear |
| 80 | Tributylphosphate | 20 | Crystal | Crystal at 5° C. |
| | | | | clear at 10° C. |
| 75 | Tributylphosphate | 25 | Crystal | Crystal |
| 70 | Tributylphosphate | 30 | Crystal | Crystal |
| 65 | Tributylphosphate | 35 | Crystal | Clear |
| 50 | Tributylphosphate | 50 | Crystal | Clear |
| 30 | Tributylphosphate | 70 | Clear | Clear |
| 66.7 | triethylphosphate | 33.3 | Crystal | Clear |
| 50 | triethylphosphate | 50 | Clear | Clear |
| 70 | Matrilox IL001M | 30 | Crystal | Clear |
| 70 | Aromatic 200 | 30 | Crystal | Clear |
| 65 | CE-810K | 35 | Crystal | Clear |
| 70 | CE-810K | 30 | Crystal | Clear |
| (Emerion W 90 PA) | | | | |
| 65 | Isopar L mineral | 35 | Crystal | Clear |
| | oil | | | |
| 65 | Isopar L mineral | 35 | Crystal | Clear |
| (Emerion W 90 PA) | oil | | | |
| 65 | Syfat 2LT (TOFA) | 35 | Crystal | Crystal |
| 65 | Syfat 2LT | 35 | Crystal | Clear |
| (Emerion W 90 PA) | | | | |
| 70 | Methyl benzoate | 30 | Crystal | Clear |
| 70 | Exxal 9 | 30 | Crystal | Clear |
| 65 | Arneel C | 35 | Crystal | Clear |
| 60 | Hexanol-3PO | 40 | Crystal | Clear |
| 75 | Heptanoic acid | 25 | Crystal | Clear |
| 75 | Neo Heptanoic | 25 | Crystal | Clear |
| | acid (CAS# | | | |
| | 95823-36-2) | | | |
| 70 | Valeric C5 acid | 30 | Crystal | Clear |

The data shows that to lower the melting point of pelargonic acid to 0° C. (or lower), it requires to use 25% ethyl acetate, heptanoic acid, or neo heptanoic acid; 30% 2-EH acid, 2-EH alcohol, Exxal 9 (branched C9 alcohol), hexanol, d-limonene, octyl lactate, Matrilox IL001M, and methyl benzoate, valeric acid, or Aromatic 200; 33.3% triethyl phosphate; or 35% CE-810K (C8-10 methyl ester), methyl salicylate, tributyl phosphate, tall oil fatty acid (TOFA), or Arneel C (coco nitrile). The data also shows that it is easier to lower the melting point of Emerion W 90 PA (90% pelargonic acid and 6% C8-C10 acids) than the >97% pelargonic acid grade.

The low melting point pelargonic acid compositions with suitable diluents are useful for backpack and drone applications without dilution with water. The low melting point pelargonic acid compositions with suitable diluents are also useful as the basis for formulating pelargonic acid emulsion concentrates with low melting points.

### Example 2

### Pelargonic Acid ECs with Various Alkoxylated Alkyl Phosphate Esters and Their Emulsions

Emulsion concentrates (ECs) were obtained by mixing pelargonic acid, alkoxylated alkyl phosphate esters of the disclosure, and optionally other emulsifiers and neutralizing bases. The compositions of ECs without diluents are set forth below.

| | C9 acid, | | Surfactant, | | wt % of |
|---|---|---|---|---|---|
| EC ID | wt % | Surfactant | wt % | Base | Base |
| EC1 | 90 | PE1 | 10 | | |
| (e) | | | | | |
| EC2 | 89.78 | PE1 | 9.39 | NH4OH | 0.83 |
| | | | | (29%) | |
| EC3 | 88.15 | PE1 | 9.79 | NH4OH | 2.06 |
| | | | | (29%) | |
| EC4 | 83.33 | PE2 | 16.67 | | |
| EC5 | 90 | PE2 | 10 | | |
| EC6 | 90 | PE3 | 10 | | |
| (e) | | | | | |
| EC7 | 92 | PE4 | 8 | | |
| EC8 | 90 | PE4 | 10 | | |
| EC9 | 80 | PE4 | 20 | | |
| EC10 | 90 | PE4 + C1618- | 9.1 + 9 | | |
| | | 23EO | | | |
| EC11 | 90 | PE4 + C1618- | 8.3 + 1.7 | | |
| | | 23EO | | | |
| EC12 | 90 | PE4 + C1618- | 7.7 + 2.3 | | |
| | | 23EO | | | |
| EC13 | 90 | PE4 + C1618- | 6.7 + 3.3 | | |
| | | 23EO | | | |
| EC14 | 90 | PE4 + C1618- | 5 + 5 | | |
| | | 23EO | | | |
| EC15 | 90 | PE5 | 10 | | |
| EC16 | 89.71 | PE8 | 9.97 | MEA | 0.32 |
| EC17 | 89.37 | PE8 | 9.93 | MEA | 0.7 |
| EC18 | 90 | PE8 | 10 | | |
| EC19 | 89.87 | PE8 | 9.99 | MEA | 0.15 |
| EC20 | 89.73 | PE8 | 9.97 | MEA | 0.3 |
| EC21 | 89.42 | PE8 | 9.94 | MEA | 0.64 |
| EC22 | 88.99 | PE8 | 9.89 | MEA | 1.13 |
| EC23 | 88.85 | PE8 | 8.88 | MEA | 2.27 |
| (e) | | | | | |
| EC24 | 88.76 | PE8 | 9.86 | IPA | 1.38 |
| EC25 | 85.23 | PE8 | 9.47 | IPA | 5.3 |
| EC26 | 81.52 | PE8 | 9.06 | IPA | 9.42 |
| (e) | | | | | |
| EC27 | 81 | PE8 | 9 | IPA | 10 |
| EC28 | 76.79 | PE8 | 8.53 | IPA | 14.68 |
| (e) | | | | | |
| EC29 | 90 | PE10 | 10 | | |
| EC30 | 89.31 | PE10 | 9.92 | MEA | 0.76 |
| EC31 | 90 | PE9 | 10 | | |
| EC32 | 90 | PE12 | 10 | | |
| (e) | | | | | |
| EC33 | 90 | PE13 | 10 | | |
| (e) | | | | | |
| EC34 | 85 | PE24 | 15 | | |
| EC35 | 90 | Emulpon CO-550 | 10 | | |
| (c) | | | | | |
| EC36 | 90 | Ethylan NS- | 10 | | |
| (c) | | 500LQ | | | |
| EC37 | 90 | C1618-23EO | 10 | | |
| (c) | | | | | |
| EC38 | 85 | Emphos CS-141 | 15 | | |
| (c) | | | | | |
| EC39 | 85 | PE21 | 15 | | |
| (e) | | | | | |

(e) means the EC was diluted to water and the resulting emulsion data was obtained.
(c) means comparative examples.

The surfactants used in the comparative examples are well known emulsifiers in various applications. However, all comparative examples had poor emulsions when diluted to water at 5%. Emphos CS-141 is a nonylphenol-10EO phosphate ester and it is a similar product to Stepfac 8170 (used in TABLE II of U.S. Pat. No. 4,975,110).

The emulsions of pelargonic acid ECs without diluents are set forth below.

| | | Water | | | | | 20-24 hrs |
|---|---|---|---|---|---|---|---|
| Emulsion | | (to | Cream amount, % volume | | | | Bulk emulsion |
| ID | EC ID | 100%) | 0.5 hr | 0.5-4 hrs | | >20 hours | whiteness |
| 2.1 | 5.73% | 34 ppm | 0 | 5 | (3 hours) | 7 + 1% | Very Good |
| | EC1 | | | | | bottom clr | |
| 2.2 | | 343 ppm | 0 | 1 | (3 hours) | <1 | Excellent |
| 2.3 | | 1000 ppm | 0 | 2 | (3 hours) | 7 + 1% | Very Good |
| | | | | | | bottom clr | |
| 2.4 | 5.69% | 34 ppm | 2 | 18 (3 hours, | | 1 (bottom | Excellent |
| | EC6 | | | no clear | | clr), no more | |
| | | | | boundary) | | cream | |
| 2.5 | | 343 ppm | <1 | <1 | (3 hours) | <1 | Excellent |
| 2.6 | | 1000 ppm | <1 | <1 | (3 hours) | <1 | Excellent |
| 2.7 | 5% | Tap | 2 | 4 | (2 hr) | 6 | Good |
| | EC23 | water | | | | | |
| 2.8 | 5.52% | Tap | <1 | 1 | (1 hr) | | Very good |
| | EC26 | water | | | | | |
| 2.9 | 5.86% | Tap | <1 | <1 | (2 hours) | | Translucent, no |
| | EC28 | water | | | | | separation |
| 2.10 | 5.69% | 34 ppm | 3 | | | | A little |
| 2.11 | EC46 | 343 ppm | 2 | | | | Fair |
| 2.12 | | 1000 ppm | 2 | | | | Fair |
| 2.13 | 5.69% | 34 ppm | 3 | | | | Good |
| | EC48 | | | | | | |
| 2.14 | 5% | 1000 ppm | 1 | 3 | (1 hour) | 4 | Excellent |
| | EC39 | | | | | | |

Ranking of emulsions according to their whiteness: excellent, very good, good, fair, a little. Translucent without separation belongs to “excellent” category.

### Example 3

### Pelargonic Acid ECs with Diluents and Various Alkoxylated Alkyl Phosphate Esters and Their Emulsions

The compositions of ECs with diluents are set forth below.

| | | | | | | | wt % |
|---|---|---|---|---|---|---|---|
| | C9 acid, | | wt % of | | Surf, | | of |
| EC ID | wt % | Diluent | Diluent | Surfactant | wt % | Base | Base |
| EC40 | 58.88 | d-limonene | 25.23 | PE9 | 15.89 | | |
| EC41 | 63 | Sylfat 2 | 27 | PE9 | 10 | | |
| EC42 | 70 | Sylfat 2 | 18.25 | PE9 | 6.75 | IPA | 5 |
| EC43 | 63.01 | Sylfat 2 | 22.5 | PE9 | 8.32 | IPA | 6.16 |
| EC44 | 61.78 | Sylfat 2 | 22.06 | PE9 + | 8.16 + 1.96 | IPA | 6.04 |
| | | | | Witconate 93S | | | |
| EC45 | 73 | Sylfat 2 | 18.25 | PE9 + | 6.75 + 2 | | |
| | | | | Witconate 93S | | | |
| EC47 | 90 | Sylfat 2LT | 7.3 | PE12 | 2.7 | | |
| EC49 | 54.69 | 2-EH acid | 23.44 | PE10 | 8.68 | IPA | 13.19 |
| (e) | | | | | | | |
| EC50 | 58.23 | 2-EH acid + | 24.95 + 1.85 | PE10 | 7.39 | IPA | 7.58 |
| (e) | | Sylfat 2 | | | | | |
| EC51 | 54.78 | 2-EH acid + | 23.48 + 1.74 | PE10 | 6.96 | IPA | 13.04 |
| (e) | | Sylfat 2 | | | | | |
| EC52 | 54.78 | 2-EH acid + | 23.48 + 4.35 | PE10 | 4.35 | IPA | 13.04 |
| (e) | | Sylfat 2 | | | | | |
| EC53 | 53.85 | 2-EH acid + | 23.08 + 5.98 | PE10 | 2.56 | IPA | 13.04 |
| (e) | | Sylfat 2 | | | | | |
| EC54 | 60 | 2-EH acid + | 23.04 + 4.28 | PE10 | 4.28 | IPA | 8.4 |
| (e) | | Sylfat FA1 | | | | | |
| EC55 | 70 | 2-EH acid + | 10 + 10 | PE10 | 10 | | |
| (e) | | Tributyl | | | | | |
| | | phosphate | | | | | |
| EC56 | 63 | 2-EH acid | 27 | PE1 | 10 | | |
| (e) | | | | | | | |
| EC57 | 63 | 2-EH acid | 27 | PE8 | 10 | | |
| (e) | | | | | | | |
| EC58 | 63 | 2-EH acid | 27 | PE7 | 10 | | |
| (e) | | | | | | | |
| EC59 | 45 | 2-EH acid | 45 | PE7 | 10 | | |
| (e) | | | | | | | |
| EC60 | 27 | 2-EH acid | 63 | PE7 | 10 | | |
| (e) | | | | | | | |
| EC61 | 63 | 2-EH acid | 27 | PE13 | 10 | | |
| (e) | | | | | | | |
| EC62 | 61.4 | 2-EH acid + | 26.32 + 2.53 | PE5 | 9.75 | | |
| (e) | | water | | | | | |
| EC63 | 56.46 | Hexanol | 24.2 | PE12 | 19.34 | | |
| (e) | | | | | | | |
| EC64 | 60.35 | Hexanol | 25.86 | PE12 | 13.79 | | |
| (e) | | | | | | | |
| EC65 | 63 | Hexanol | 27 | PE12 | 10 | | |
| (e) | | | | | | | |
| EC66 | 63 | Hexanol | 27 | PE9 | 10 | | |
| (e) | | | | | | | |
| EC67 | 63 | Hexanol | 27 | PE13 | 10 | | |
| (e) | | | | | | | |
| EC68 | 92 | | | PE1 | 8 | | |
| EC69 | 63 | 2-EH acid | 27 | PE14 | 13 | | |
| EC70 | 63 | 2-EH acid | 27 | PE10 + | 5 + 5 | | |
| | | | | Witconate 93S | | | |
| EC71 | 63 | 2-EH acid | 27 | PE9 + | 5 + 5 | | |
| | | | | Witconate 93S | | | |
| EC72 | 63 | 2-EH acid | 27 | PE13 + | 5 + 5 | | |
| (e) | | | | Witconate 93S | | | |
| EC73 | 62.9 | 2-EH acid | 26.96 | PE3 + | 5.29 + 4.85 | | |
| | | | | Witconate 93S | | | |
| EC74 | 59.46 | 2-EH acid + | 25.48 + 5.47 | PE3 + | 5 + 4.59 | | |
| | | water | | Witconate 93S | | | |
| EC75 | 73 | Sylfat 2 | 17.92 | PE9 | 6.63 | IPA | 2.45 |
| EC76 | 73 | Sylfat 2 | 16.59 | PE9 + | 6.14 + 2 | IPA | 2.27 |
| | | | | Witconate 93S | | | |
| EC77 | 60 | 2-EH acid + | 26 + 1 | PE10 + | 4.1 + 7 | IPA | 1.9 |
| | | Sylfat 1 | | Witconate 93S | | | |
| EC78 | 63 | Sylfat 2LT | 27 | PE9 + | 4.5 + 4.5 | IPA | 1 |
| | | | | Witconate 93S | | | |
| EC79 | 63 | 2-Eh acid + | 27 + 1 | PE13 + | 5.5 + 3.5 | | |
| | | water | | Witconate 93S | | | |
| EC80 | 63 | 2-Eh acid + | 27 + 1 | PE13 + | 5 + 4 | | |
| | | water | | Witconate 93S | | | |
| EC81 | 63 | 2-Eh acid + | 27 + 1 | PE13 + | 4.7 + 4.3 | | |
| | | water | | Witconate 93S | | | |
| EC82 | 63 | 2-Eh acid + | 27 + 1 | PE13 + | 4.5 + 4.5 | | |
| | | water | | Witconate 93S | | | |
| EC83 | 63 | 2-Eh acid + | 27 + 1 | PE13 + | 4.2 + 4.8 | | |
| | | water | | Witconate 93S | | | |
| EC84 | 63 | 2-Eh acid + | 27 + 1 | PE13 + | 4 + 5 | | |
| | | water | | Witconate 93S | | | |
| EC85 | 63 | 2-Eh acid + | 27 + 1 | PE13 + | 3.5 + 5.5 | | |
| | | water | | Witconate 93S | | | |
| EC86 | 59.5 | 2-Eh acid + | 25.5 + 1.5 | PE13 + | 5.25 + 8.25 | | |
| (e) | | water | | Witconate 93S | | | |
| EC87 | 59.5 | 2-Eh acid + | 25.5 + 1.5 | PE13 + | 6.75 + 6.75 | | |
| | | water | | Witconate 93S | | | |
| EC88 | 59.5 | 2-Eh acid | 25.5 | PE15 + | 5.72 + 9.28 | | |
| (e) | | | | Witconate 93S | | | |
| EC89 | 63 | 2-EH | 27 | PE1 | 10 | | |
| | | alcohol | | | | | |
| EC90 | 71 | 2-EH | 18 | PE1 | 10 | | |
| | | alcohol | | | | | |
| EC91 | 75 | 2-EH | 15 | PE1 | 10 | | |
| (e) | | alcohol | | | | | |
| EC92 | 81 | 2-EH | 9 | PE1 | 10 | | |
| | | alcohol | | | | | |
| EC93 | 45 | Matrilox | 45 | PE4 | 10 | | |
| | | IL001M | | | | | |
| EC94 | 56.91 | Hexanol | 24.4 | PE13 + | 13.09 + 5.61 | | |
| (e) | | | | Ethomeen | | | |
| | | | | SV/25 | | | |
| EC95 | 56.91 | Hexanol | 24.4 | PE16 + | 13.09 + 5.61 | | |
| (e) | | | | Ethomeen | | | |
| | | | | SV/25 | | | |
| EC96 | 56.91 | Hexanol | 24.4 | PE15 + | 13.09 + 5.61 | | |
| (e) | | | | Ethomeen | | | |
| | | | | SV/25 | | | |
| EC97 | 56.91 | Hexanol | 24.4 | PE18 + | 13.09 + 5.61 | | |
| (e) | | | | Ethomeen | | | |
| | | | | SV/25 | | | |
| EC98 | 56.91 | Hexanol | 24.4 | PE19 + | 13.09 + 5.61 | | |
| (e) | | | | Ethomeen | | | |
| | | | | SV/25 | | | |
| EC99 | 59.5 | Hexanol | 25.5 | PE16 + | 10.5 + 4.5 | | |
| (e) | | | | Ethomeen | | | |
| | | | | SV/25 | | | |
| EC100 | 85 | | | PE24 | 15 | | |
| EC101 | 62.48 | 2-EH acid + | 26.78 + 0.82 | PE18 + | 4.96 + 4.96 | | |
| (e) | | water | | Witconate 93S | | | |
| EC102 | 45 | Matrilox | 45 | C16-3EO PE | 10 | | |
| (c) | | IL001M | | | | | |
| EC103 | 45 | Matrilox | 45 | C13-4EO PE | 10 | | |
| (c) | | IL001M | | | | | |
| EC104 | 63 | Hexanol | 27 | C13-6EO PE | 10 | | |
| (c) | | | | | | | |
| EC106 | 63 | 2-EH | 27 | Emulpon CO- | 10 | | |
| (c) | | alcohol | | 360 | | | |
| EC107 | 63 | 2-EH | 27 | Sponto EC-452 | 10 | | |
| (c) | | alcohol | | | | | |
| EC108 | 63 | 2-EH acid | 27 | PE18 + | 5 + 5 | | |
| | | | | Witconic 1298S | | | |
| EC 109 | 59.5 | 2-EH acid | 25.5 | PE18 + | 5.5 + 3.25 | NH4OH- | 6.25 |
| (e) | | | | Witconic 1298S | | 29% | |
| EC 110 | 59.5 | 2-EH acid | 25.5 | PE17 | 15 | | |
| EC 111 | 59.5 | 2-EH acid | 25.5 | PE17 + | 7.5 + 7.5 | | |
| (e) | | | | Witconic1298S | | | |
| EC 112 | 61.1 | Heptanoic | 26.2 + 3 | PE18 | 9.7 | | |
| (e) | | acid + water | | | | | |
| EC 113 | 40 | Heptanoic | 20 | PE17 | 40 | | |
| | | acid | | | | | |

(e) means the EC was diluted to water and the resulting emulsion data was obtained.
(c) is indicative of a comparative example.

Sylfat is tall oil fatty acid. Witconate 93S is isopropylamine salt of Witconic 1298S (C10-16-alkyl benzenesulfonic acid). Matrilox IL001M is C5-C9 monocarboxylic acid mixture (<15% C9 acid). Emulpon CO-550 and Emulpon CO-360 are ethoxylated castor oil with 55 and 36 EOs, respectively. Ethomeen SV/25 is ethoxylated soya amine with 15 EOs. Sponto EC-452 is a blend of emulsifiers. Ethylan NS-500LQ is emulsifier consists of oxirane, methyl-, polymer with oxirane, mono[2-(2-butoxyethoxy)ethyl]ether. Phospholan PS-131 is C13-6EO phosphate ester.

Sometimes EC samples may be hazy. It is discovered that adding some water improves sample appearance. Therefore, water may be advantageously added.

Examples of emulsions of pelargonic acid ECs with alkyl phosphate esters are shown below. The emulsions were obtained by adding EC to water in an emulsion tube, followed by inverting the emulsion tube for 10 to 15 times. Emulsion stability was observed in various time intervals. The water hardness was 34 ppm water (soft water), tap water (similar to soft water), 342 ppm water, or 1000 ppm water.

Emulsion whiteness ratings (visual) are excellent, very good, good, fair, and a little.

| | | | | | | | | | 20-24 hrs |
|---|---|---|---|---|---|---|---|---|---|
| | | Water | | | | | | | Bulk |
| Emulsion | | (to | | Cream amount, % volume | | | | | emulsion |
| ID | EC ID | 100%) | | 0.5 hr | 0.5-4 hrs | | >20 hours | | whiteness |
| 3.1 | 5.76% | Tap | | <1 | 2 | (3 hours) | 3 | (24 hours) | Excellent |
| | EC49 | water | | | | | | | |
| 3.2 | 5.41% | Tap | | <1 | | | 5 | (3 days) | Excellent |
| | EC50 | water | | | | | | | |
| 3.3 | 5.75% | Tap | | <1 | 3 | (4 hours) | 3 | (24 hours) | Excellent |
| | EC51 | water | | | | | | | |
| 3.4 | 5.75% | Tap | | <1 | 3 | (4 hours) | 3 | (24 hours) | Excellent |
| | EC52 | water | | | | | | | |
| 3.5 | 5.85% | Tap | | <1 | 1 | (3 hours) | 3 | (24 hours) | Excellent |
| | EC53 | water | | | | | | | |
| 3.6 | 6.17% | Tap | | 4 | 5 | (1 hour) | 6 | (24 hours) | Good |
| | EC54 | water | | | | | | | |
| 3.7 | | 343 | ppm | 4 | 5 | (1 hour) | 6 | (24 hours) | Good |
| 3.8 | 5.85% | Tap | | 2 | 5 | (2 hours) | | | A little |
| | EC55 | water | | | | | | | |
| 3.9 | 5.69% | 34 | ppm | 2 | 6 | (2 hours) | 8 + 1 | | Good |
| | EC56 | | | | | | (bottom clr) | | |
| 3.10 | | 343 | ppm | <1 | 1 | (2 hours) | 2 | | Excellent |
| 3.11 | | 1000 | ppm | <1 | <1 | (2 hours) | <1 | | Excellent |
| 3.12 | 5.69% | 34 | ppm | 5 | 8 | (2 hours) | 10 + 2 | | A little |
| | EC57 | | | | | | (bottom clr) | | |
| 3.13 | | 343 | ppm | <1 | <1 | (2 hours) | 3 | | Excellent |
| 3.14 | | 1000 | ppm | <1 | <1 | (2 hours) | 4 | | Excellent |
| 3.15 | 5.69% | 34 | ppm | >4% | | | | | A little |
| 3.16 | EC58 | 343 | ppm | <1 | 2 | (hours) | 4 | | Very good |
| 3.17 | | 1000 | ppm | <1 | 2 | (hours) | 7 | | Very good |
| 3.18 | 5.67% | 343 | ppm | 0 | | | 3 | | Excellent |
| 3.19 | EC59 | 1000 | ppm | 0 | | | 3 | | Excellent |
| 3.20 | 5.67% | 343 | ppm | 0 | | | 3 | | Excellent |
| 3.21 | EC60 | 1000 | ppm | 0 | | | <1 | | Excellent |
| 3.22 | 5.69% | Tap | | 3 | 7 | (2 hours) | | | Good |
| | EC61 | water | | | | | | | |
| 3.23 | 4.2% | 343 | ppm | <1 | 1 | (2 hours) | | | Very good |
| | EC61 | | | | | | | | |
| 3.24 | 5.69% | 34 | ppm | 3 | 8 | (3 hr) | 15 | | Good |
| 3.25 | EC62 | 343 | ppm | 1 | 3 | (3 hr) | 11 + 1 | | Excellent |
| | | | | | | | (bottom clr) | | |
| 3.26 | 6.2% | 34 | ppm | 3 | 1 hr 7% | | | | A little |
| 3.27 | EC63 | 34 | ppm | | 1 hr 2% | | 24 hr 4% | | Good |
| | | (+0.133 | | | | | | | |
| | | % AMS) | | | | | | | |
| 3.28 | | 343 | ppm | <1 | 3 hr 1% | | 24 hr 4% | | Very good |
| 3.29 | | 1000 | ppm | <1 | 2 hr 1% | | 24 hr 4% | | Very good |
| | | | | | | | (top clr) | | |
| 3.30 | 5.8% | 34 | ppm | <1 | 1 hr 3% | | 24 hr 6% | | Good |
| | EC64 | (+0.11% | | | | | | | |
| | | AMS) | | | | | | | |
| 3.31 | | 34 | ppm | <1 | 2 hr 2% | | 48 hr 5% | | Very good |
| | | (+0.31% | | | | | | | |
| | | AMS) | | | | | | | |
| 3.32 | | 343 | ppm | <1 | 2 hr 2% | | 24 hr 5% | | Very good |
| 3.33 | 5.56% | 343 | ppm | 2 | | | 24 hr 6% | | A little |
| | EC65 | (+0.3% | | | | | | | |
| | | AMS) | | | | | | | |
| 3.34 | | 343 | ppm | 1 | 2 hr 2% | | 48 hr 6% | | Good |
| | | (+0.61% | | | | | | | |
| | | AMS) | | | | | | | |
| 3.35 | 5.56% | 34 | ppm | 1 | 2 hr 3% | | 24 hr 5% | | Good |
| | EC66 | (+0.6% | | | | | | | |
| | | AMS) | | | | | | | |
| 3.36 | 5.56% | 34 | ppm | 5 | | | | | |
| 3.37 | EC67 | 343 | ppm | 2 | 1 hr 3% | | 5 days 9% | | Very good |
| 3.38 | | 1000 | ppm | 1 | 2 hr 4% | | | | Very good |
| 3.39 | 5.69% | 34 | ppm | 4 | 7 | (1 hr) | | | A little |
| 3.40 | EC72 | 34 | ppm | 3 | 6 | (1 hr) | 11 | (5 days) | Good |
| | | (+0.13% | | | | | | | |
| | | IPA) | | | | | | | |
| 3.41 | | 343 | ppm | 1 | 3 | (2 hours) | 7 | (5 days)* | Very good |
| 3.42 | | 1000 | ppm | <1 | <1 | (2 hrs) | <1 | (5 days) | Excellent |
| 3.43 | 5.88% | Tap | | <1 | <1 | (1 hour) | 1 | (24 hours) | Excellent |
| | EC86 | water | | | | | | | |
| 3.44 | 6% | 1000 | ppm | 0 | 0 | | 0 | (24 hours) | Excellent |
| | EC86 | | | | | | | | |
| 3.45 | 5.8% | Tap | | <1 | 1 | (1 hr) | 8 | | Excellent |
| | EC88 | water | | | | | (boundary | | |
| | | | | | | | not obvious) | | |
| 3.46 | 5% | 1000 | ppm | <1 | <1 | (2 hours) | 1 | (24 hours) | Good |
| | EC91 | | | | | | | | |
| 3.47 | 6.15% | Tap | | 0 | 0 | (2 hours) | <1 | (24 hours) | Excellent |
| | EC94 | water | | | | | | | |
| 3.48 | 6.15% | Tap | | 0 | 0 | (2 hours) | <1 | (24 hours) | Excellent |
| | EC95 | water | | | | | | | |
| 3.49 | 6.15% | Tap | | 0 | 0 | (2 hours) | <1 | (24 hours) | Excellent |
| | EC96 | water | | | | | | | |
| 3.50 | 6.15% | Tap | | 0 | <1 | (2 hours) | <1 | (24 hours) | Excellent |
| | EC97 | water | | | | | | | |
| 3.51 | 6.15% | Tap | | 0 | 1 | (2 hours) | 2 | (24 hours) | Excellent |
| | EC98 | water | | | | | | | |
| 3.52** | 5% | Tap | | 0 | 0 | (4 hours) | | | Excellent |
| | EC99 | water | | | | | | | |
| 3.53 | 5% | 1000 | ppm | 0 | <1 | (2 hours) | 2 | (24 hours) | Excellent |
| | EC101 | | | | | | | | |
| 3.54 | 6% | Tap | | 0 | <1 | (3 hours) | 1 | (24 hours) | Excellent |
| | EC109 | water | | | | | | | |
| 3.55 | | 1000 | ppm | <1 | 2 | (3 hours) | 5 | | Good |
| 3.56 | 6% | 342 | ppm | 0 | <1 | (2 hours) | <1 | (24 hours) | Excellent |
| | EC111 | | | | | | | | |
| 3.57 | 6% | 1000 | ppm | 0 | 0 | | 2 | (3 days)* | Excellent |
| | EC112 | | | | | | | | |

*is indicative of no separation 30 minutes after re-inversion
**is indicative that the EC was aged for 14 days at room temperature before diluting to water.

It appears that the emulsion performance of the ECs comprising the phosphate esters of the disclosure is better in 343 ppm and 1000 ppm hard water than in 34 ppm (and tap) water.

Almost all aged emulsions (>20 hours) had separation but they were able to re-mix back to original emulsion with one or two inversions.

### Example 4

### Pelargonic Acid ECs Using Other Pelargonic Acid Sources and Their Emulsions

Some commercial products contain less than 97% pelargonic acid. Examples are Emerion W 90 PA (90% C9 acid) from Emery Oleochemicals, Emery 1202 (90% C9 acid) and Emery 1210 (27% C9 acid) from BASF/Cognis, and PRIFRAC 2914 (90% C9 acid) from Croda.

Emulsion concentrates (ECs) were obtained by mixing Emerion W 90 PA or Emery 1202 with alkoxylated phosphate esters of the disclosure. The compositions of ECs are listed below. In the table below, C9 is indicative of pelargonic acid.

| | C9 acid | | | wt % of | | |
|---|---|---|---|---|---|---|
| EC ID | Brand | wt % | Diluent | Diluent | Surfactant | Surf, wt % |
| EC4.1 | Emery | 89.78 | | | PE1 | 10.22 |
| EC4.2 | 1202 | 89.78 | | | PE3 | 10.22 |
| EC4.3 | | 89.78 | | | PE4 | 10.22 |
| EC4.4 | | 89.78 | | | PE6 | 10.22 |
| EC4.5 | | 53.93 | 2-EH acid | 35.96 | PE3 | 10.11 |
| EC4.6 | | 67.5 | 2-EH acid | 22.5 | PE8 | 10 |
| EC4.7 | | 90 | 2-EH acid + | 1.22 + 1.65 | PE4 | 7.13 |
| | | | water | | | |
| EC4.8 | | 86 | 2-EH acid + | 1.7 + 2.32 | PE4 | 9.98 |
| | | | water | | | |
| EC4.9 | | 88.88 | | | PE1 | 11.12 |
| EC4.10 | | 88.88 | | | PE2 | 11.12 |
| EC4.11 | | 88.88 | | | PE3 | 11.12 |
| EC4.12 | | 88.88 | | | PE4 | 11.12 |
| EC4.13 | | 66.7 | Mineral oil | 23.3 | PE1 | 10 |
| EC4.14 | Emerion | 90 | | | PE15 | 10 |
| EC4.15 | W 90 PA | 90 | | | PE15 + Ethomeen | 7 + 3 |
| | | | | | SV/25 | |

The aforementioned ECs were used to form the following emulsions. The emulsions were obtained by adding the EC to water, followed by inverting the emulsion for 10 times. Emulsion stability was observed in various time intervals. The table below sets forth ECs made with pelargonic acid (90% purity) with alkyl phosphate esters.

| | | | | | | | | 16 hrs Bulk |
|---|---|---|---|---|---|---|---|---|
| Emulsion | | Water (to | | Cream amount, % volume | | | | emulsion |
| ID | EC ID | 100%) | | 0.5 hr | 0.5-2 hr | | 16-24 hrs | whiteness |
| 4.1 | 6.2% | 343 | ppm | | 7 | (3 hr) | 9 + 3 (bottom | Good |
| | EC4.1 | | | | | | clr) | |
| 4.2a | 6.2% | 343 | ppm | <1 | <1 | (3 hr) | 4 (bottom clr) | Excellent |
| 4.2b | EC4.2 | 1000 | ppm | 3 | | | <1 | Excellent |
| 4.3a | 6.2% | 343 | ppm | 0 | <1 | (3 hr) | 10 + 1 (bottom | very good |
| | EC4.3 | | | | | | clr) | |
| 4.3b | | 1000 | ppm | 0 | | | 3 | Excellent |
| 4.4 | 6.2% | 343 | ppm | <2 | 4 | (3 hr) | 9 + 3 (bottom | Very good |
| | EC4.4 | | | | | | clr) | |
| 4.5 | 5.93% | 1000 | ppm | <1 | 5 | (2 hours) | 10 (16 hrs) | Excellent |
| | EC4.5 | | | | | | | |
| 4.6a | 7.4% | 343 | ppm | 1 | | | 10 | Good |
| 4.6b | EC4.6 | 1000 | ppm | <1 | | | 1 | Good |
| 4.7a | 5% | 343 | ppm | 2 | 5 | (1 hour) | | Good |
| 4.7b | EC4.7 | 1000 | ppm | <1 | 1 | (1 hour) | | Good |
| 4.8 | 5% | 342 | ppm | | 3 | (1 hr) | | Good |
| | EC4.8 | | | | | | | |
| 4.9 | 5% | 342 | ppm | 0 | 0 | | <1 | Excellent |
| | EC4.9 | | | | | | | |
| 4.10 | 5% | 342 | ppm | 0 | <1 | (2 hours) | 10 | Good |
| | EC4.10 | | | | | | | |
| 4.11 | 5% | 342 | ppm | 0 | 0 | | <1 | Excellent |
| | EC4.11 | | | | | | | |
| 4.12 | 5% | 342 | ppm | 0 | 0 | | <1 | Excellent |
| | EC4.12 | | | | | | | |
| 4.13 | 5% | 342 | ppm | 0 | 0 | | 2 | Excellent |
| | EC4.13 | | | | | | | |
| 4.14a | 5% | Tap water | | 1 | 2 | (1 hour) | | |
| 4.14b | EC4.14 | 1000 | ppm | <1 | 1 | (1 hour) | | |
| | | | | | 3 | (7 hours) | | |
| 4.15a | 5% | Tap water | | 1 | 2 | (1 hour) | | |
| | EC4.15 | | | | 5 | (7 hours) | | |
| 4.15b | | 1000 | ppm | <1 | 1 | (1 hour) | | |
| | | | | | 2 | (7 hours) | | |

All aged emulsions (16-24 hours) had separation but they were able to re-mix back to white emulsion with one or two inversions.

### Example 5

### Tank-Mix Application of Pelargonic Acid EC

It is a common practice that an end user combines a tank-mix additive with an emulsion. Examples of the tank-mix additives used in the disclosure are ammonium sulfate (AMS), Base Camp Amine 4 (46.8% 2,4-D DMA), Roundup PowerMax (540 g ae/1 K-glyphosate), Clarity (58% dicamba salt), and Liberty 280 (24.5% NH4 glufosinate). They can be added to water first or added after emulsions are formed. Tank mix compatibility results, i.e., the emulsions after mixing, are set forth below.

5% EC56 was diluted to water (comprising various herbicides) with hardness of 34 ppm, 342 ppm, and 1000 ppm water in a long tube (˜400 mm in length). Bloom and emulsion after 10 inversions were observed.

| | | | | | | | | | 20-24 hrs |
|---|---|---|---|---|---|---|---|---|---|
| | | Water | | | | Cream (% vol.) | | | Bulk |
| Emul | | (to | | Tank mix | wt % of | 0.5 | 0.5- | >20 | emulsion |
| ID | EC ID | 100%) | | additive | additive | hr | 3 hrs | hrs | whiteness |
| 5.1 | 5% | 34 | ppm | Base Camp | 4% | 2 | 6 (2 hrs) | 7 | A little |
| | EC56 | | | Amine 4 | | | | | |
| 5.2 | | 343 | ppm | Base Camp | 1% | 3 | 5 (2 hrs) | 7 | A little |
| | | | | Amine 4 | | | | | |
| 5.3 | | 343 | ppm | Base Camp | 2% | 2 | 4 (2 hrs) | 6 | Good |
| | | | | Amine 4 | | | | | |
| 5.4 | | 1000 | ppm | Roundup | 2% | 0 | 1 (2 hrs) | 1 | Excellent |
| | | | | PowerMax | | | | | |
| 5.5 | | 34 | ppm | Roundup | 2% | 0 | 2 (2 hrs) | 1 | Excellent |
| | | | | WeatherMax | | | | | |
| 5.6 | | 1000 | ppm | Clarity | 1% | 0 | <1 (2 hrs) | 6 | Excellent |
| 5.7 | | 343 | ppm | Liberty 280 | 2% | 0 | 2 (2 hrs) | 4 | Excellent |
| 5.8 | 5.69% | 34 | ppm | AMS | 0.50% | 0 | 2 (3 hrs) | 4 | Very good |
| | EC62 | | | | | | | | |
| 5.9 | 5.73% | 34 | ppm | AMS | 0.50% | 0 | <1 (3 hrs) | 1 | Excellent |
| | EC15 | | | | | | | | |
| 5.10 | 5% | 34 | ppm | AMS | 0.25% | 0 | <1 (3 hrs) | 2 | Excellent |
| | EC15 | | | | | | | | |
| 5.11 | 5.73% | 34 | ppm | AMS | 0.50% | 0 | <1 (3 hrs) | 3 | Excellent |
| | EC1 | | | | | | | | |
| 5.12 | 5% | 342 | ppm | Base Camp | 1% + 0.5% | | 3 (3 hrs) | 5 | Good |
| | EC56 | | | Amine 4 + | | | | | |
| | | | | AMS | | | | | |
| 5.13 | 5.69% | 34 | ppm | AMS | 0.5 | | 3 (3 hrs) | 6 | Good |
| | EC56 | | | | | | | | |
| 5.14 | 5.73% | 34 | ppm | AMS | 0.2 | | | 10 | Good |
| | EC6 | | | | | | | | |
| 5.15 | 5.69% | 34 | ppm | AMS | 0.2 | 1 | 4 (2 hrs) | 6 | Good |
| | EC58 | | | | | | | | |
| 5.16 | 5.67% | 34 | ppm | AMS | 0.5 | 1 | | 6 | Good |
| | EC59 | | | | | | | | |
| 5.17 | 5.65% | 34 | ppm | AMS | 0.5 | 2 | | 6 | Good |
| | EC59 | | | | | | | | |

There was no flocculation in all samples in the table above. That is, the ECs are compatible with Base camp Amine 4 (2,4-D salt), Roundup PowerMax (glyphosate salt), Roundup WeatherMax (glyphosate salt), Clarity (dicamba salt), Liberty 280 (glufosinate salt), and ammonium sulfate. All aged emulsions were able to turn back to a good emulsion after one or two inversions.

### Example 6

### Wetting Synergy Between Pelargonic Acid and Alkyl Phosphate Ester

It was unexpectedly discovered that there is a synergy in wetting/spreading between C9 acid and phosphate ester exemplified by PE2 (C1216-30 phosphate ester). Both C9 acid in water and PE2 in water (0.5-3.7%) are not able to wet a hydrophobic polystyrene dish. That is, a drop of the solution balls up with a large contact angle on the dish. However, when blending a 3.3% C9 acid with 3.3% PE2, for example, 90% (3.3% C9 acid)+10% (3.3% PE2), the wetting is better and it covers a larger area.

| ID | 3.3% C9 acid | 3.3% PE2 | Wetting Evaluation |
|---|---|---|---|
| 6.1 | 100% | 0% | Poor wetting |
| 6.2 | 90% | 10% | Better wetting and spreading |
| 6.3 | 0% | 100% | Poor wetting |

Good wetting is important for a contact pesticide like pelargonic acid because it needs to cover as a large area as possible.

### Example 7

### Greenhouse Bioefficacy

A greenhouse trial was performed to compare the bioefficacy of the benchmark Scythe and the bioefficacy of the pelargonic acid ECs of the disclosure. Two species were used—spring wheat and morning glory. The trial was run using 4 replicas for each weed species. The rating was done 3 days after treatment. The compositions of the samples are shown in the table below.

| | Sample # | | |
|---|---|---|---|
| | 7.1 (Scythe) | 7.2 | 7.3 |
| Pelargonic acid | 57 | 63 | 63 |
| Other fatty acid | 3 | | |
| Inert Oil | 30 | | |
| Emulsifier | 10 | | |
| Alfol 6 hexanol | | | 27 |
| PE15 | | 5 | 10 |
| 2-EH acid | | 27 | |
| Witconate 93S (IPA | | 5 | |
| dodecylbenzenesulfonate) | | | |

Greenhouse bioefficacy trial:

| | | | |
|---|---|---|---|
| Spray solution, % v/v | 8.33 | 5.56 | 5.56 |
| % C9 acid in spray | 5 | 3.5 | 3.5 |
| solution | | | |
| Spray volume, gal/A | 80 | 80 | 80 |
| Spring wheat, % control | 74 | 69 | 69 |
| Morning glory, % control | 94 | 97 | 95 |
| Comment | Benchmark | Statistically same as | Statistically same |
| | | benchmark | as benchmark |

The efficacy result shows that 5.56% Sample 7.2 and 5.56% Sample 7.3 have equivalent efficacy as 8.33% Scythe. That is, the diluent 2-EH acid in Sample 7.2 and the diluent hexanol in Sample 7.3, in combination with the phosphate ester PE15, are able to enhance the efficacy of pelargonic acid.

### Example 8

### Additional Efficacy Studies

A dipping experiment was performed to compare the efficacy performance of benchmark Scythe with various pelargonic acid ECs of the disclosure. A few live leaves, staying on growing plants on ground, are dipped (or immersed) into a test sample and a control sample. The live leaves can be from the same plant—one can be dipped into the test sample and the other can be dipped into the control sample. After dipping, the sample is removed and the leaves are left on the plants. After a certain period of time, the symptom (damage to the leaf) is assessed by eyes and photographed by a camera. This dipping method has an advantage over traditional spraying methods. It gives more consistent results between different runs. It eliminates potential errors associated with traditional spraying methods resulting from inaccurate spray volume, wind speed, weeds difference due to growing in different pots, and canopy blocking effect. This dipping method is particularly suitable for contact herbicides such as pelargonic acid because the damage symptom appears very quickly (a few minutes to a few hours depending on weed species).

The compositions of the samples and the results are shown in below. Each comparison experiment was done on a different date and it compared the efficacy performance of a 8.33% Scythe emulsion (the control sample) with a pelargonic acid emulsion of various concentration (the test sample).

| Sample # | C9 acid (grade) | Diluent | Surfactant |
|---|---|---|---|
| 8.1 (Scythe) | 57% (pure) + 3% | 30% (mineral oil) | 10% unknown surf |
| | other acids | | |
| 8.2 | 90% (97%) | | 10% PE2 |
| 8.3 | 63% (97%) | 27% (2-Eh acid) | 10% PE1 |
| 8.4 | 54% (90%, | 36% (2-Eh acid) | 10% PE16 |
| | Emery 1202) | | |
| 8.5 | 90% (90%, | | 10% PE16 |
| | Emery 1202) | | |
| 8.6 | 90% (97%) | | 10% PE10 |
| 8.7 | 63% (97%) | 27% (2-Eh acid) | 5% PE10 + 5% |
| | | | Witconate 93S |
| 8.8 | 40% (97%) | 20% (C7 acid) | 40% PE17 |
| (i.e., EC113) | | | |

The ECs were diluted in water and leaves were dipped into the diluted solutions while staying on plants. Scythe was used as the benchmark. The dipping solution concentration and efficacy results after 14-24 hours is shown below:

| | | | % (C9 acid + other | |
|---|---|---|---|---|
| Sample | Dilution | % C9 acid in | acids + 2-EH acid) in | |
| # | wt % | dipping emulsion | dipping emulsion | Damage/efficacy |
| 8.1 | 8.33 | 4.75 | 5 | Benchmark |
| (Scythe) | | | | (control) |
| 8.2^{a} | 5.72 | 5 | 5 | Faster symptom and |
| | | | | better efficacy than |
| | | | | benchmark |
| 8.3 ^{a} | 5.67 | 3.46 | 5 | Faster symptom and |
| | | | | better efficacy than |
| | | | | benchmark |
| 8.4 ^{a} | 5.94 | 2.9 | 5.34 | Faster symptom and |
| | | | | better efficacy than |
| | | | | benchmark |
| 8.5 ^{a} | 6.17 | 5 | 5.55 | Better efficacy than |
| | | | | benchmark |
| 8.6^{b} | 5% + | 4.4 | 4.4 | Similar to |
| | 0.52 IPA | | | benchmark (after 7 |
| | | | | hours) |
| 8.7^{c} | 5 | 3.06 | 4.4 | Similar to |
| | | | | benchmark |
| 8.8^{c} | 5 | 2 | 3 | Similar to |
| | | | | benchmark |

^{a}Herba houttuyniae
^{b}Tomato leaves
^{c}Amaranthus tricolor

### Example 9

### Pelargonic Acid EC Comprising Phosphate Esters from Castor Oil Ethoxylate

Various ECs are formed and set forth below. These ECs include phosphate esters of castor oil ethoxylate.

| | C9 acid | C9 acid, | 2-EH | | | | wt % of |
|---|---|---|---|---|---|---|---|
| EC ID | Grade | wt % | acid, wt % | PE | PE, wt % | Co-surf | co-surf |
| 9a.1 | C9 acid | 59.5 | 25.5 | PE20 | 7.5 | Witconate | 7.5 |
| | 97% | | | | | 93S | |
| 9a.2 | C9 acid | 63 | 27 | PE20 | 5 | Witconate | 5 |
| | 97% | | | | | 93S | |
| 9a.3 | Emerion | 52.90% | 22.7 | PE20 | 5.6 | DDBSA + | 7.3 + 11.5 |
| | W 90 PA | | | | | DMAPA | |
| 9a.4 | Emerion | 85% | | PE20 | 15 | | |
| | W 90 PA | | | | | | |
| 9a.5 | Emerion | 59.50 | 25.500 | PE20 | 15.00 | | |
| | W 90 PA | | | | | | |
| 9a.6 | C9 acid | 85.00 | | PE21 | 15.00 | | |
| | 97% | | | | | | |
| 9a.7 | C9 acid | 59.50 | 25.500 | PE21 | 15.00 | | |
| | 97% | | | | | | |
| 9a.8 | Emerion | 59.50 | 25.500 | PE21 | 15.00 | | |
| | W 90 PA | | | | | | |

DDBSA is dodecylbenzenesulfonic acid (Witconic 1298S). DMAPA is dimethylamidopropylamine.

After formation, emulsions of pelargonic acid ECs comprising phosphate ester of castor oil ethoxylate are formed, as set forth below, and visually evaluated.

| | | | | | | | Separation - 30 |
|---|---|---|---|---|---|---|---|
| | | | Separation | | | 24 hrs Bulk | mins after re- |
| Emulsion | wt % | Water (to | amount, % volume | | | emulsion | shaking 24 hrs |
| ID | EC | 100%) | 0.5 hr | 2 hrs | 24 hrs | whiteness | sample |
| 9b.1a | 6% | 1000 ppm | 0 | <1% | <1% | Excellent | 0 |
| | EC9a.1 | | | | | | |
| 9b.1b | 6% | Tap | 1% | 3% | 9% | Excellent | 1% |
| | EC9a.1 | water | | | | | |
| 9b.2 | 6% | 342 ppm | 1% | 3% | 11% | Excellent | 2% |
| | EC9a.2 | | | | | | |
| 9b.3 | 7.15% | Tap | | | 4% | Excellent | |
| | EC9a.3 | water | | | | (bluish) | |
| 9b.4 | 5.9% | Tap | 1% | 3% | 13% | Good | 2% |
| | EC9a.4 | water | | | | | |
| 9b.5 | 5.9% | Tap | <1% | 2% | 13% | Good | 2% |
| | EC9a.5 | water | | | | | |
| 9b.6 | 5% | 1000 ppm | 1% | | 4% | Excellent | 0% |
| | EC9.a6 | | | | | | |
| 9b.7 | 5% | 1000 ppm | 1% | | 4% | Excellent | 0% |
| | EC9.a7 | | | | | | |
| 9b.8 | 5% | 1000 ppm | 1% | 3% | 18%* | Excellent | 0%* |
| | EC9.a8 | | | | | | |

*18% bottom clear after 3 days. However, no separation occurred 30 minutes after reinversion.

Adding 0.3 g ammonium sulfate to 100 g emulsion ID 9b.1b and ID 9b.2, the cream amount was reduced to 2% (2 hours).

It appears phosphate esters of castor oil ethoxylate, PE20 and PE21, behaves similarly to ethoxylated alkyl phosphate esters of the disclosure.

### Example 10

### Pesticide Compositions Comprising Pelargonic Acid and Another Pesticide and Alkoxylated Phosphate Esters

Pesticide compositions comprising pelargonic acid and another pesticide and alkoxylated phosphate esters are formed as set forth below.

| | EC of Pelargonic acid + another pesticide | | | 5% dilution in water | | |
|---|---|---|---|---|---|---|
| | | Pesticide + | Phos. | | 0.5 hr, % | 2 hr, % |
| EC ID | C9 acid | diluent | ester | Water | separation | separation |
| 10.1 | 77% Emerion | 16.5% | 16.5% | Tap Water | <1% | 2% |
| | W 90 PA | Etridiazole | PE20 | 1000 ppm | 0% | 1% |
| 10.2 | 70% Emerion | 15% | 15% | Tap Water | 1% | 4% |
| | W 90 PA | Malathion | PE20 | 1000 ppm | <1% | 2% |
| 10.3 | 70% Emerion | 15% 2,4-D | 15% | Tap Water | 1% | 4% |
| | W 90 PA | octyl ester | PE20 | 1000 ppm | 1% | 4% |
| 10.4 | 70% Emerion | 15% 2,4-D | 15% | 1000 ppm | 0% | 1% |
| | W 90 PA | octyl ester | PE18 | | | |
| 10.5 | 69.5% Emerion | 15.6% | 15% | 1000 ppm | <1% | 1% |
| | W 90 PA | Acetochlor | PE18 | | | |
| 10.6 | 70% Emerion | 15% | 15% | 1000 ppm | <1% | 1% |
| | W 90 PA | Clethodim | PE18 | | | |
| 10.7 | 50% C9 acid | 44% | 6% | 1000 ppm | <1% | 4% |
| | (97%) | Acetochlor | PE18 | | | |
| 10.8 | 49% C9 acid | 45% 2,4-D | 6% | Tap Water | 0 | 0 |
| | (97%) | octyl ester | PE18 | 1000 ppm | 0 | 0 |
| 10.9 | Emerion W | 15% | 10% | 1000 ppm | <1% | 3% |
| | 90 PA | Acetochlor + | PE18 | | | |
| | | 15% 2-EH | | | | |
| | | acid | | | | |
| 10.10 | 60% Emerion | 20% | 10% | 1000 ppm | 1% | 3% |
| | W 90 PA | Cycloate + | PE18 | | | |
| | | 10% 2-EH | | | | |
| | | acid | | | | |
| 10.11 | 60% C9 acid | 5% 2,4-D | 10% | 1000 ppm | 1% | 2% (4% |
| | (97%) | acid + 25% | PE18 | | | 24 hrs) |
| | | 2-Eh acid | | | | |
| 10.12 | 60% C9 acid | 5% Dicamba | 10% | 1000 ppm | 0% | <1% (1% |
| | (97%) | acid + 25% | PE18 | | | 24 hrs) |
| | | 2-Eh acid | | | | |
| 10.13 | 50% C9 acid | 40% | 10% PE- | Tap water | 0% | <1% (4 hr |
| | (97%) | Acetochlor | 21 | | | 1%) |
| 10.14 | 49.18% C9 | 2.19% | 25.84% | Tap water | 2% | 4% (24 hr |
| | acid (97%) | imazethapyr + | PE-6 | (4% dilution) | | 4%) |
| | | 4.56% water + | | 1000 ppm | Trace | 2% (24 hr |
| | | 18.24% | | (4% dilution) | | 2%) |
| | | benzaldehyde | | | | |

Dicamba herbicide and 2,4-D acid herbicide are solids and all other pesticides are liquid at room temperature.

### Example 11

### Pelargonic Acid ECs Containing Phosphate Ester of Ethoxylated Tallowamine and Their Emulsions

| | EC of Pelargonic acid + diluent | | | Emulsion | | | |
|---|---|---|---|---|---|---|---|
| EC | C9 acid | | Phosphate | % EC in | 0.5 hr, % | 1 hr, % | 24 hr, % |
| ID | (97%) | diluent | ester | water | Cream | Cream | Cream |
| 11.1 | 59.5% | 25.5% | 15% PE23 | 6% in Tap | 0% | 0% | 2% |
| | | Matrilox | | water | | | |
| | | IL001M | | 6% in 1000 | 0% | 0% | <1% |
| | | | | ppm | | | |
| 11.2 | 59.5% | 25.5% 2- | 15% PE23 | 5% in 1000 | 1% | 1.7% | 3% |
| | | EH acid | | ppm | | | |
| 11.3 | 59.5% | 25.5% 2- | 5% PE23 + | 6% in tap | 0% | <1% | <2% |
| | | EH acid | 5% PE17 + | water | | | |
| | | | 5% PE22 | 6% in 342 | 0% | 0% | <1% |
| | | | | ppm | | | |

The data shows that the phosphate ester from tallowamine-40EO is an excellent emulsifier for C9 acid ECs. The emulsions shown in the above table were stable and the emulsion whiteness was excellent.

The data set forth above indicates that all emulsion bloom was good to excellent. The emulsions were re-inverted after 24 hours and the emulsions had similar separation 30 minutes after re-inversion.

### Example 12

### Ready-to-Use Emulsions

Ready-to-use products are convenient for non-professional consumers to use without diluting to water. The phosphates esters of the disclosure are also found useful in making ready-to-use emulsions containing the linear C5-C10 fatty acids. In this case, no diluent is necessary unless the diluent can provide added efficacy.

Ready-to-use emulsions can be prepared by mixing (shaking) the fatty acids of the disclosure and water first by hand vigorously for 5 to 10 seconds, followed by adding the phosphate esters and shaking by hand vigorously for 5 to 10 seconds. Heating may be needed if the phosphate esters or blends of phosphate esters with other surfactants do not dissolve quickly in water. Additional shaking may be necessary after 20 to 60 minutes. In manufacturing plants, mixing can be done with proper devices and methods known to the art.

Examples of the ready-to-use emulsions are shown below.

### Ready-to Use Emulsions

| Sample | | | Water, | Phosphate | | |
|---|---|---|---|---|---|---|
| ID | Fatty acid | wt % | wt % | Ester | wt % | Observation |
| 12.1 | C5 (valeric) | 5 | 94.5 | PE17 | 0.5 | White emulsion, no |
| | acid | | | | | obvious separation |
| | | | | | | after 2 weeks at room |
| | | | | | | temp |
| 12.2 | Heptanoic | 5 | 94.5 | PE17 | 0.5 | White emulsion, no |
| | (C7) acid | | | | | obvious separation |
| | | | | | | after 2 weeks at room |
| | | | | | | temp |
| 12.3 | C9 acid + C7 | 2.5 + 2.5 | 94.5 | PE17 | 0.5 | White emulsion, no |
| | acid | | | | | obvious separation |
| | | | | | | after 2 weeks at room |
| | | | | | | temp |

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing an exemplary embodiment. It being understood that various changes may be made in the function and arrangement of elements described in an exemplary embodiment without departing from the scope as set forth in the appended claims.

What is claimed is:

1. An agrochemical composition comprising:
a linear fatty acid having a C5 to C10 alkyl chain; and
an additive chosen from a diluent, an alkoxylated phosphate ester surfactant, and combinations thereof,
wherein the alkoxylated phosphate ester surfactant has a degree of alkoxylation of from about 10 to about 100 and is chosen from alkoxylated C12-C22 alkyl phosphate esters, alkoxylated phosphate esters formed from an alkoxylated triglyceride having at least one pendant hydroxyl group, an alkoxylated phosphate ester formed from an alkoxylated alkylamine, and combinations thereof; and
wherein the diluent is chosen from C4-C10 linear or branched alcohols and their propoxylates, branched C5-C10 monocarboxylic acids, methyl and ethyl esters of linear or branched C8-C10 fatty acids, tall oil fatty acid, trialkyl C2-C8 linear or branched phosphates, aromatic solvents, mineral oils, methyl benzoate, methyl salicylate, octyl acetates, octyl lactate, alkylnitriles, and combinations thereof.

2. The agrochemical composition of claim 1 wherein the linear fatty acid is pelargonic acid and is optionally present in an amount of from about 20 to about 95 wt % actives based on a total weight of the composition.

3. The agrochemical composition of claim 1 wherein the alkoxylated phosphate ester is present and is ethoxylated to a degree of ethoxylation of from about 12 to about 40.

4. The agrochemical composition of claim 1 wherein the alkoxylated phosphate ester is present and is chosen from an alkoxylated branched C13 alkyl phosphate ester, an alkoxylated linear C12-C16 alkyl phosphate ester, an alkoxylated linear C16-C18 alkyl phosphate ester, and combinations thereof.

5. The agrochemical composition of claim 1 wherein the alkoxylated phosphate ester is present and is formed from an alkoxylated triglyceride chosen from alkoxylated castor oil, alkoxylated epoxidized triglycerides, and combinations thereof.

6. The agrochemical composition of claim 1 wherein the alkoxylated phosphate ester is present and is formed using a starting molar equivalent ratio of phosphating agent to hydroxyl group of from about 1:3 to about 1:1.

7. The agrochemical composition of claim 1 wherein the alkoxylated phosphate ester is present and comprises a molar ratio of mono- to di-phosphate esters of from about 16:1 to about 1:1.

8. The agrochemical composition of claim 1 wherein the alkoxylated phosphate ester is present and comprises less than about 40 wt % actives of unreacted alkoxylated alcohol based on a total weight of the alkoxylated phosphate ester.

9. The agrochemical composition of claim 1 that is free of the diluent and comprises the alkoxylated phosphate ester.

10. The agrochemical composition of claim 1 wherein
the diluent is present and is chosen from 2-ethyhexaonic acid, tall oil fatty acid, 2-ethyhexanol, hexanol, and combinations thereof; or
the diluent is present and is chosen from d-limonene, mineral oil, and combinations thereof; or
the diluent is present and the composition is free of the alkoxylated phosphate ester.

11. The agrochemical composition of claim 1 further comprising a second surfactant chosen from alkylbenzene sulfonic acid, isopropylamine salts of a C8-C10 linear or branched carboxylic acids, isopropylamine salts of tall oil fatty acid, alkylamine alkoxylates, alcohol ethoxylates, and combinations thereof.

12. The agrochemical composition of claim 1 further comprising a base chosen from isopropylamine, monoethanolamine, dimethylamidopropylamine, ammonium hydroxide, and combinations thereof.

13. The agrochemical composition of claim 1 wherein the alkoxylated phosphate ester is present in an amount from greater than about zero up to about 20 wt % actives based on a total weight of the composition.

14. The agrochemical composition of claim 1 wherein the diluent is present in an amount of greater than zero and less than about 80 wt % actives based on a total weight of the composition.

15. The agrochemical composition of claim 1 that has a melting point of less or equal to about 5° C.

16. The agrochemical composition of claim 1 further comprising a pesticide different from the linear fatty acid.

17. The agrochemical composition of claim 16 wherein
the pesticide comprises an herbicide chosen from glyphosate, dicamba, glufosinate, cycloate, acetochlor, clethodim, imidazolinone, and combinations thereof;
the pesticide comprises a fungicide optionally comprising etridiazole; and/or
the pesticide comprises an insecticide optionally comprising malathion.

18. A tank-mix composition comprising the agrochemical composition of claim 1 and a tank-mix additive optionally comprising ammonium sulfate.

19. A method comprising the steps of providing the agrochemical composition of claim 1 and applying the agrochemical composition to a target.

20. The method of claim 19 wherein the agrochemical composition is not diluted with water prior to the step of applying.
